(19) United States
(12) Patent Application Publication
(10) Pub. No.: US 2010/0328416 A1
(43) Pub. Date: Dec. 30, 2010

(54) LIGHT EMITTING DEVICE, PRINT HEAD, IMAGE FORMING APPARATUS, LIGHT AMOUNT CORRECTION METHOD OF PRINT HEAD AND COMPUTER READABLE MEDIUM

(75) Inventors: Chikaho Ikeda, Kanagawa (JP); Kiyofumi Aikawa, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/762,490

(22) Filed: Apr. 19, 2010

(30) Foreign Application Priority Data
Jun. 26, 2009 (JP) 2009-152949
Oct. 28, 2009 (JP) 2009-248253

(51) Int. Cl. B41J 2/45; H05B 37/02

(52) U.S. Cl. 347/236; 315/297; 347/238

(57) ABSTRACT

A light emitting device is provided with: a self-scanning light emitting element array that includes light emitting elements divided into plural groups, light-controlled for each of the groups, and arrayed in line; and a light-up controller that sets any one of a voltage and a current for light-up, in accordance with the number of light emitting elements intended to light up in each of the groups.

### CROSS REFERENCE TO RELATED APPLICATIONS

This application is based on and claims priority under 35 USC §119 from Japanese Patent Applications No. 2009-248253 filed Oct. 28, 2009 and No. 2009-152949 filed Jun. 26, 2009.

### BACKGROUND

1. Technical Field

The present invention relates to a light emitting device, a print head, an image forming apparatus, a light amount correction method of print head and a computer readable medium storing a program.

2. Related Art

In an image forming apparatus such as a printer, a copy machine, a facsimile machine or the like, which employs an electrophotographic method, image formation is performed as follows. On a uniformly charged photoconductor, an electrostatic latent image is obtained by irradiation of the image information by the optical recording unit, then the electrostatic latent image is visualized with toner, and finally the visualized image is transferred and fixed onto the recording sheet.

### SUMMARY

According to an aspect of the present invention, there is provided a light emitting device including: a self-scanning light emitting element array that includes light emitting elements divided into plural groups, light-controlled for each of the groups, and arrayed in line; and a light-up controller that sets any one of a voltage and a current for light-up, in accordance with the number of light emitting elements intended to light up in each of the groups.

### BRIEF DESCRIPTION OF THE DRAWINGS

An exemplary embodiment of the present invention will be described in detail based on the following figures, wherein:

FIG. 1 is a diagram for explaining an example of an overall configuration of an image forming apparatus to which the present exemplary embodiment is applied;

FIG. 2 is a view for explaining a structure of the print head to which the present exemplary embodiment is applied;

FIG. 3 is a top view of the light emitting device;

FIG. 4 is a diagram for explaining a wire configuration of the light emitting chips, the signal generating circuit, and the light-up signal feeding circuit in the light emitting device;

FIG. 5 is a diagram for explaining a circuit configuration of the light emitting chip;

FIGS. 6A and 6B are views for explaining the outline of the light-up control on the light emitting chip;

FIGS. 7A to 7C illustrate methods for correcting, for each group, the light exposure amount of the light emitting thyristors belonging to a group;

FIG. 8 is a timing chart for explaining operations of the light emitting chip;

FIG. 9 is a timing chart for explaining another operation of the light emitting chip;

FIG. 10 is a block diagram showing a configuration of the signal generating circuit;

FIG. 11 is a diagram for explaining each of the light-up control signal generating units and each of the light-up signal feeding circuits included in the signal generating circuit;

FIG. 12 is a diagram for explaining the reference electric current generating portion;

FIG. 13 is a logic circuit diagram for explaining the light-up control signal feeding portion;

FIG. 14 is a circuit diagram for explaining the electric current supplying circuit;

FIG. 15 is a circuit diagram for explaining the light-up signal speedup portion;

FIG. 16 is a circuit diagram for explaining the light-up signal feeding circuit;

FIG. 17 is a circuit diagram for explaining another circuit configuration of the light-up signal feeding circuit;

FIG. 18 is a block diagram for explaining a configuration of the reference clock generating unit of the signal generating circuit;

FIG. 19 is a block diagram for explaining the light-up period setting portion;

FIG. 20 is a flowchart for explaining the operation of correcting the light-up period of the light emitting thyristor, performed in the light-up control signal generating unit; and

FIGS. 21A, 21B, and 21C are graphs for explaining the electric current value of the light-up control signal outputted from the light-up signal feeding circuit in the case of using the electric current supplying circuits (three-state buffers) in Table 2.

### DETAILED DESCRIPTION

Hereinafter, a description will be given of an exemplary embodiment of the present invention in detail with reference to the accompanying drawings.

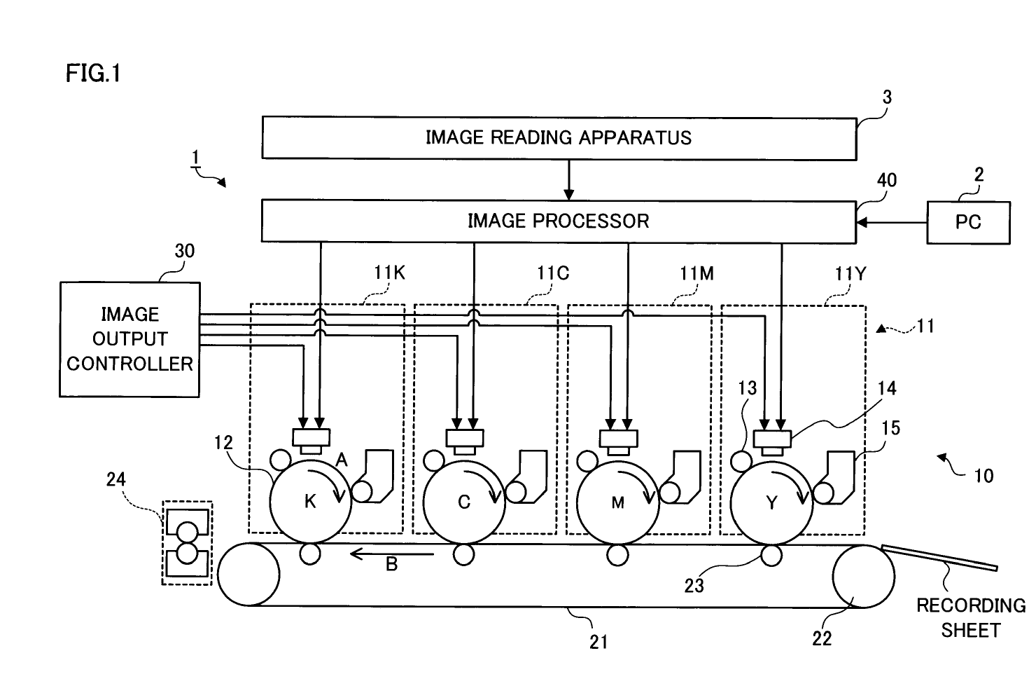

FIG. 1 is a diagram for explaining an example of an overall configuration of an image forming apparatus 1 to which the present exemplary embodiment is applied. The image forming apparatus 1 shown in FIG. 1 is what is generally termed as a tandem image forming apparatus. The image forming apparatus 1 includes an image forming process unit 10, an image output controller 30 and an image processor 40. The image forming process unit 10 forms an image in accordance with respective color image datasets. The image output controller 30 controls the image forming process unit 10. The image processor 40, which is connected to devices such as a personal computer (PC) 2 and an image reading apparatus 3, performs predefined image processing on image data received from the above devices.

The image forming process unit 10 includes image forming units 11 formed of multiple engines arranged in parallel at regular intervals. The image forming units 11 are formed of four image forming units 11Y, 11M, 11C and 11K. Each of the image forming units 11Y, 11M, 11C and 11K includes a photoconductive drum 12, a charging device 13, a print head 14 and a developing device 15. On the photoconductive drum 12, which is an example of an image carrier, an electrostatic latent image is formed, and the photoconductive drum 12 retains a toner image. The charging device 13, as an example of a charging unit, uniformly charges the surface of the photoconductive drum 12 at a predetermined potential. The print head 14 exposes the photoconductive drum 12 charged by the charging device 13. The developing device 15, as an example of a developing unit, develops an electrostatic latent image formed by the print head 14. Here, the image forming units 11Y, 11M, 11C and 11K have approximately the same configuration excluding colors of toner put in the developing devices 15. The image forming units 11Y, 11M, 11C and 11K form yellow (Y), magenta (M), cyan (C) and black (K) toner images, respectively.

In addition, the image forming process unit 10 further includes a sheet transport belt 21, a drive roll 22, transfer rolls 23 and a fixing device 24. The sheet transport belt 21 transports a recording sheet as a transferred body so that the color toner images respectively formed on the photoconductive drums 12 of the image forming units 11Y, 11M, 11C and 11K are transferred on the recording sheet by multilayer transfer. The drive roll 22 is a roll that drives the sheet transport belt 21. Each transfer roll 23, as an example of a transfer unit, transfers a toner image formed on the corresponding photoconductive drum 12 onto the recording sheet. The fixing device 24 fixes the toner images on the recording sheet.

In this image forming apparatus 1, the image forming process unit 10 performs an image forming operation on the basis of various kinds of control signals supplied from the image output controller 30. Under the control by the image output controller 30, the image data received from the personal computer (PC) 2 or the image reading apparatus 3 is subjected to image processing by the image processor 40, and then the resultant dataset is supplied to the corresponding image forming unit 11. Then, for example in the black (K) color image forming unit 11K, the photoconductive drum 12 is charged at a predetermined potential by the charging device 13 while rotating in an arrow A direction, and then is exposed by the print head 14 emitting light on the basis of the image dataset supplied from the image processor 40. By this operation, the electrostatic latent image for the black (K) color image is formed on the photoconductive drum 12. Thereafter, the electrostatic latent image formed on the photoconductive drum 12 is developed by the developing device 15, and accordingly the black (K) color toner image is formed on the photoconductive drum 12. Similarly, yellow (Y), magenta (M) and cyan (C) color toner images are formed in the image forming units 11Y, 11M and 11C, respectively.

The respective color toner images on the photoconductive drums 12, which are formed in the respective image forming units 11, are electrostatically transferred to the recording sheet supplied with the movement of the sheet transport belt 21 by a transfer electric field applied to the transfer rolls 23, in sequence. Here, the sheet transport belt 21 moves in an arrow B direction. By this operation, a synthetic toner image, which is superimposed color-toner images, is formed on the recording sheet.

Thereafter, the recording sheet on which the synthetic toner image is electrostatically transferred is transported to the fixing device 24. The synthetic toner image on the recording sheet transported to the fixing device 24 is fixed on the recording sheet through fixing processing using heat and pressure by the fixing device 24, and then is outputted from the image forming apparatus 1.

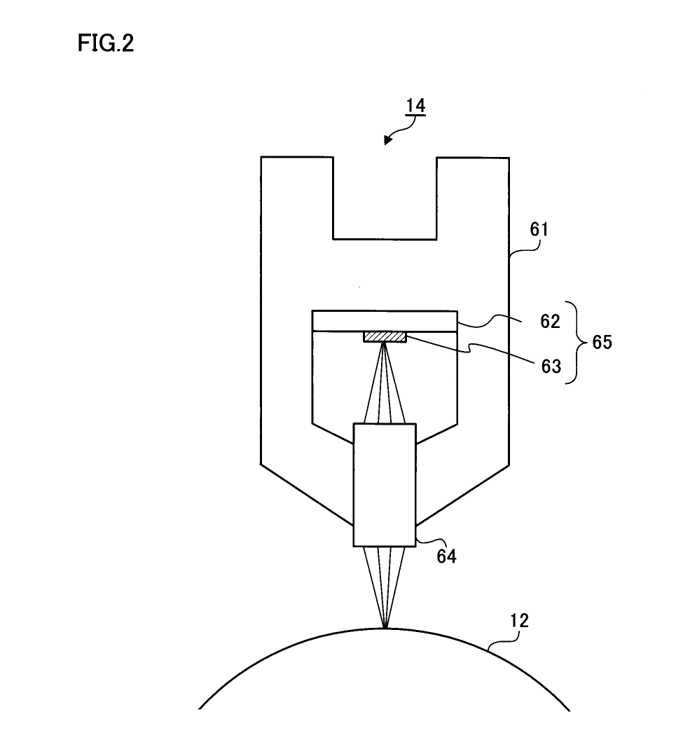

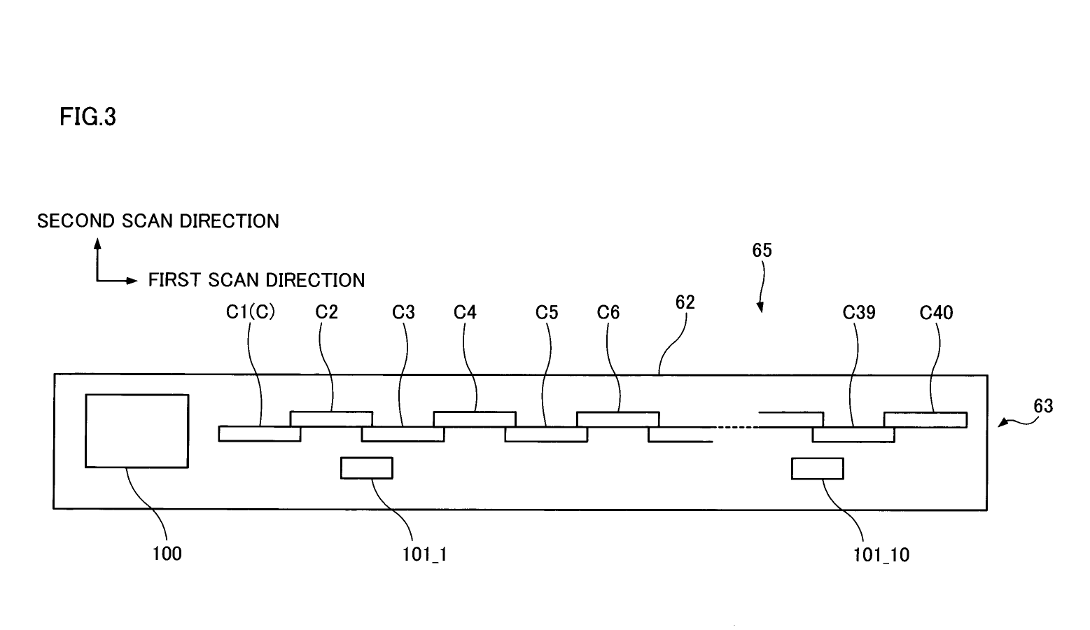

FIG. 2 is a view for explaining a structure of the print head 14 to which the present exemplary embodiment is applied. The print head 14 includes a housing 61, a light emitting portion 63, a circuit board 62 and a rod lens array 64. The light emitting portion 63 has multiple LEDs as plural light emitting portions (which are light emitting thyristors in the present exemplary embodiment). On the circuit board 62, the light emitting portion 63, a signal generating circuit 100 (see FIG. 3 to be described later) that drives the light emitting portion 63, and the like are mounted. The rod lens array 64, as an example of an optical unit, focuses light emitted by the light emitting portion 63 onto the surface of the photoconductive drum 12. Here, the light emitting portion 63, the signal generating circuit 100 and the circuit board 62 on which these components are mounted will be called a light emitting device 65 as an example of an exposure unit.

The housing 61 is made of metal, for example, and supports the circuit board 62 and the rod lens array 64. The housing 61 is set so that the light emitting points of the light emitting portions 63 coincide with the focal plane of the rod lens array 64. In addition, the rod lens array 64 is arranged along an axial direction of the photoconductive drum 12 (first scan direction).

FIG. 3 is a top view of the light emitting device 65.

As shown in FIG. 3, the light emitting portion 63 of the light emitting device 65 is formed of 40 light emitting chips C1 to C40 arranged in two lines in the first scan direction on the circuit board 62. Here, the 40 light emitting chips C1 to C40 are arrayed in a zigzag pattern in which each adjacent two of the light emitting element chips C1 to C40 face each other. Note that, if the light emitting chips C1 to C40 are not distinguished from each other, they are described as light emitting chips C or light emitting chips C (C1 to C40). The same is true for the other terms.

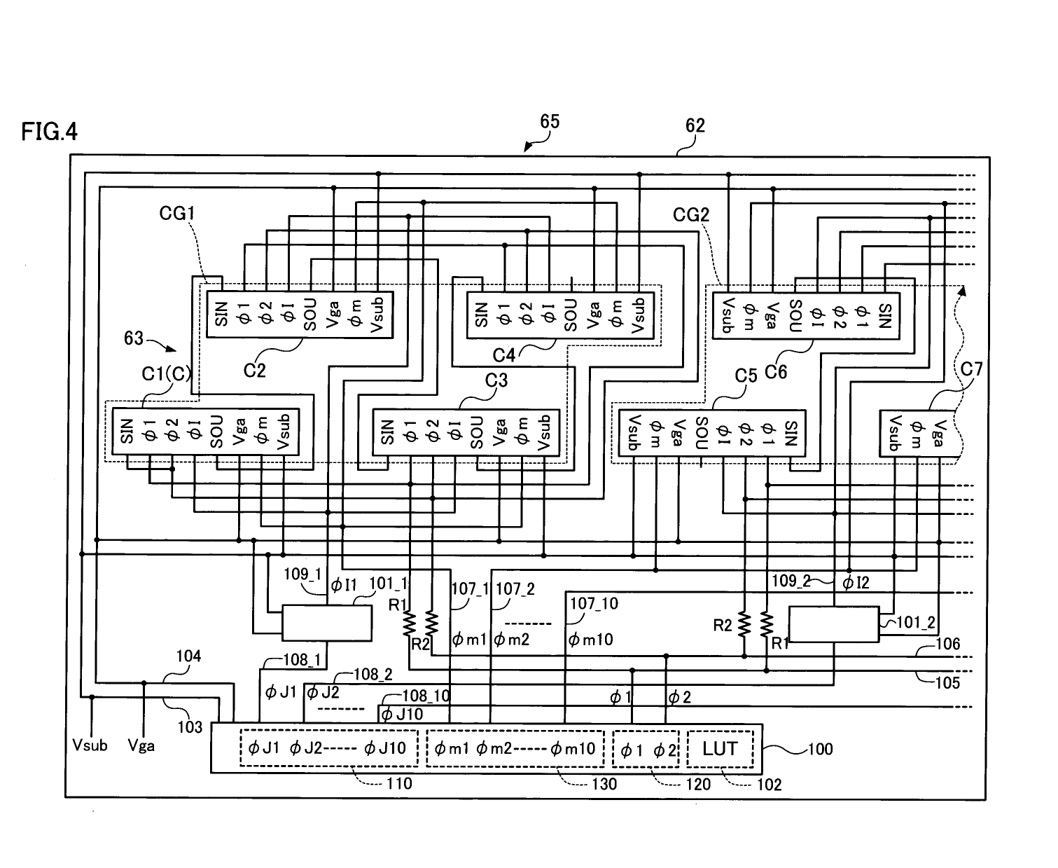

Further, the light emitting device 65 includes the signal generating circuit 100 and light-up signal feeding circuits 101 (101_1 to 101_10). The signal generating circuit 100 generates a drive signal for driving the light emitting portion 63. The light-up signal feeding circuits 101 are an example of a light-up signal supply portion that supplies a light-up signal. Note that, in the present exemplary embodiment, each light-up signal feeding circuit 101 is provided for four light emitting chips C (see FIG. 4 to be described later), as an example. Thus, the light emitting device 65 includes the light-up signal feeding circuits 101_1 to 101_10.

All of the light emitting chips C (C1 to C40) have the same configuration. Each of the light emitting chips C (C1 to C40) has the multiple light emitting points (light emitting thyristors) as described later. The light emitting points (light emitting thyristors) are arranged along long sides of the rectangular of the light emitting chips C.

On the circuit board 62, odd-numbered light emitting chips C1, C3, C5 . . . and even-numbered light emitting chips C2, C4, C6 . . . are arranged so as to face each other. In addition, the light emitting chips C1 to C40 are arranged so that the light emitting points (light emitting thyristors) are arranged at regular intervals in the first scan direction also in connecting portions of the light emitting chips C.

FIG. 4 is a diagram for explaining a wire configuration of the light emitting chips C (C1 to C40), the signal generating circuit 100, and the light-up signal feeding circuit 101 in the light emitting device 65.

In the present exemplary embodiment, for example, the light emitting chips C are driven in such a manner that four of the light emitting chips C are driven as a single light emitting chip group. Accordingly, the number of the groups is ten; a light emitting chip group CG1 includes the light emitting chips C1 to C4, and a light emitting chip group CG2 includes the light emitting chips C5 to C8 (FIG. 4 shows the light emitting chips C5 to C7). Similarly, a light emitting chip group CG 10 includes the light emitting chips C37 to C40. It should be noted that the light emitting chip group CG1 and a part of the light emitting chip group CG2 are shown in FIG. 4.

To begin with, a description will be given of the wire configuration of the signal generating circuit 100, the light emitting chips C (C1 to C40), and the light emitting chip groups CG (CG1 to CG 10).

Although not illustrated in the drawings, image data subjected to the image processing and various control signals are inputted from the image output controlling unit 30 and the image processing unit 40 (see FIG. 1) to the signal generating circuit 100. On the basis of these image data and various control signals, the signal generating circuit 100 sorts the order of the image data.

The signal generating circuit 100 includes a look-up table (LUT) 102 for correcting difference in the light exposure amounts among light emitting points (light emitting thyristors). Further, the signal generating circuit 100 includes a light-up control signal generating unit 110 that is an example of a light-up controller for outputting light-up control signals φJ (φJ1 to φJ10) to the respective light emitting chip groups CG (CG1 to CG10).

The signal generating circuit 100 includes a transfer signal generating unit 120 that outputs a first transfer signal φ1 and a second transfer signal φ2 to the light emitting chips C1 to C40 on the basis of the various control signals. Further, the signal generating circuit 100 includes a memory signal generating unit 130 that outputs memory signals φm (φm1 to φm10) for memorizing those light emitting points to light up.

In other words, the signal generating circuit 100 generates the light-up control signals φJ (φJ1 to φJ10), the memory signals φm (φm1 to φm10), the first transfer signal φ1, and the second transfer signal φ2.

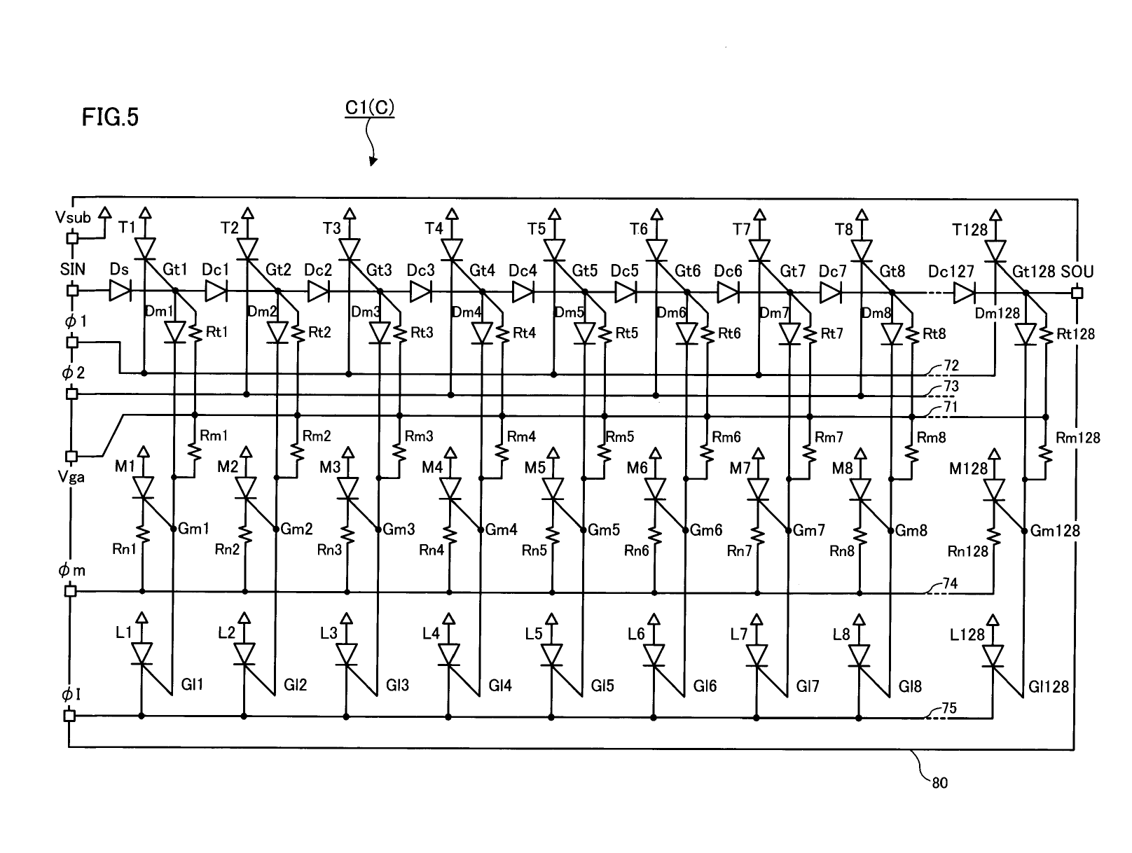

On the circuit board 62, a power supply line 103 is provided. The power supply line 103 is connected to Vsub terminals (see FIG. 5 described later) of the light emitting chips C (C1 to C40) and supplies a reference electric potential Vsub (for example, 0 V) thereto. Further, on the circuit board 62, a power supply line 104 is provided. The power supply line 104 is connected to Vga terminals (see FIG. 5 described later) of the light emitting chips C (C1 to C40) and that supplies a power supply electric potential Vga (for example, −3.3 V) thereto for power supply.

It should be noted that each of the power supply line 103 and the power supply line 104 is connected, for power supply purpose, also to the signal generating circuit 100 and the light-up signal feeding circuits 101_{—}1 to 101_{—}10.

In addition, on the circuit board 62, a first transfer signal line 105 and a second transfer signal line 106 are provided. The first transfer signal φ1 and the second transfer signal φ2 are transmitted from the transfer signal generating unit 120 of the signal generating circuit 100 to the light emitting unit 63 via the first transfer signal line 105 and the second transfer signal line 106, respectively. The first transfer signal line 105 is connected to the φ1 terminals (see FIG. 5 described later) of the light emitting chips C (C1 to C40) in parallel via the respective electric current regulation resistances R1 which are provided for the respective light emitting chip groups CG (CG1 to CG10). The second transfer signal line 106 is connected to the φ2 terminals (see FIG. 5 described later) of the respective light emitting chips C (C1 to C40) in parallel via the respective electric current regulation resistances R2 which are provided for the respective light emitting chip groups CG (CG1 to CG10).

On the circuit board 62, ten memory signal lines 107 (107_1 to 107_10) are also provided. Memory signals φm (φm1 to φm10) are transmitted from the memory signal generating unit 130 of the signal generating circuit 100 to the light emitting chip groups CG (CG1 to CG10) via the respective memory signal lines 107. Each of the memory signal lines 107 (107_1 to 107_10) is connected, in parallel, to φm terminals (see FIG. 5 described later) of the light emitting chips C belonging to corresponding one of the light emitting chip groups CG (CG1 to CG10).

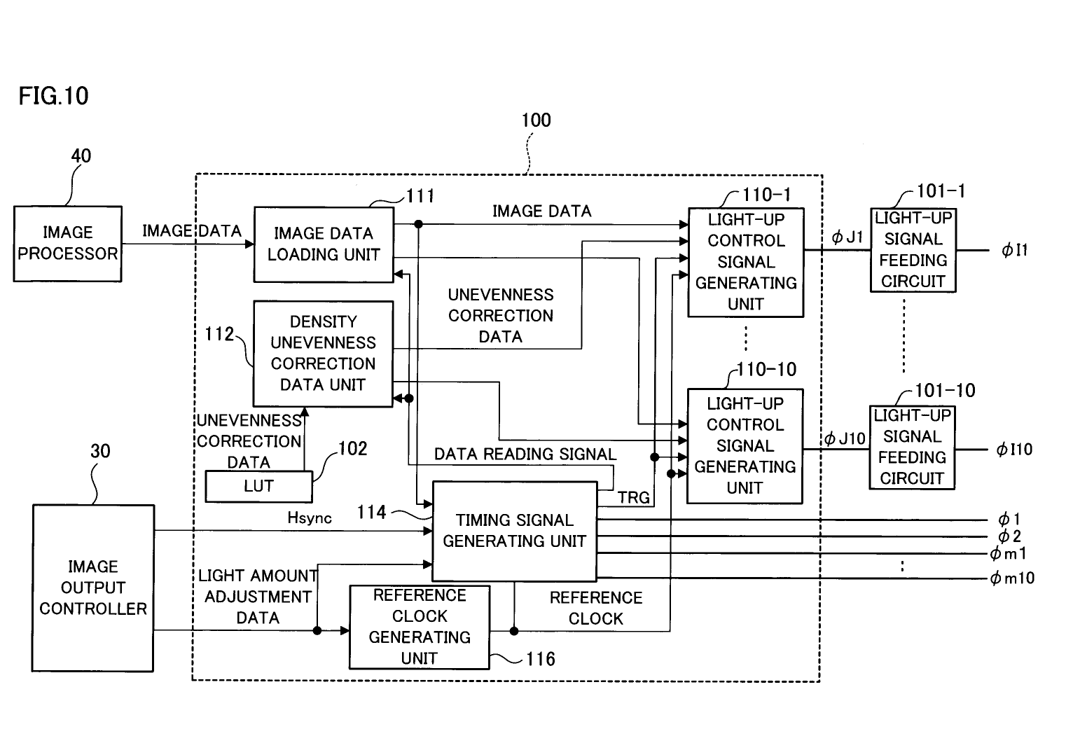

In addition, on the circuit board 62, ten light-up control signal lines 108 (108_1 to 108_10) are provided. Light-up control signals φJ (φJ1 to φJ10) are transmitted from the respective light-up control signal generating units 110_1 to 110_10 of the signal generating circuit 100 to the respective light emitting chip groups CG (CG1 to CG10) via the respective light-up control signal lines 108 (108_1 to 108_10). Each of the light-up control signal lines 108 (108_1 to 108_10) is connected to the respective light-up signal feeding circuits 101 (see FIG. 10 described later) provided for the respective light emitting chip groups CG (CG1 to CG10).

Additionally, on the circuit board 62, ten light-up signal lines 109 (109_1 to 109_10) are provided. Light-up signals φI (φI1 to φI10), corresponding to the light emitting chips C of the respective groups, are transmitted from the respective light-up signal feeding circuits 101_1 to 101_10 thereto via the respective light-up signal lines 109 (109_1 to 109_10).

Next, a wire configuration of the light emitting chips C (C1 to C40) and the light emitting chip groups CG (CG1 to CG10) will be described.

Each of the light emitting chips C (C1 to C40) includes eight terminals: a SIN terminal, the φ1 terminal, the φ2 terminal, the φI terminal, a SOU terminal, the Vga terminal, the φm terminal, and the Vsub terminal.

As mentioned above, the Vsub terminal of each light emitting chip C is connected to the power supply line 103, whereby the reference electric potential Vsub is supplied thereto. The Vga terminal is connected to the power supply line 104, whereby the power supply electric potential Vga is supplied thereto.

The φ1 terminals of the light emitting chips C for each group are concentrated and connected to one terminal of the corresponding electric current regulation resistance R1. The other terminal of the electric current regulation resistance R1 is connected to the first transfer signal line 105 for transmitting the first transfer signal φ1.

The φ2 terminals of the light emitting chips C for each group are concentrated and connected to one terminal of the corresponding electric current regulation resistance R2. The other terminal of the electric current regulation resistance R2 is connected to the second transfer signal line 106 for transmitting the second transfer signal φ2.

The φm terminals of the light emitting chips C for each group are concentrated and connected to corresponding one of the memory signal lines 107 (107_1 to 107_10).

The φI terminals of the light emitting chips C for each group are concentrated and connected to corresponding one of the light-up signal lines 109 (109_1 to 109_10), and further connected to the corresponding light-up signal feeding circuit 101 which is provided for each of the light emitting chip groups CG (CG1 to CG10) and transmits corresponding one of the light-up signals φI (φI1 to φI10).

Here, the SIN terminals and the SOU terminals will be described. In the light emitting chip group CG1 (light emitting chips C1 to C4), the SIN terminal and the φ2 terminal of the light emitting chip C1 are connected to each other, and the second transfer signal φ2 is fed thereto. The SOU terminal of the light emitting chip C1 and the SIN terminal of the light emitting chip C2 are connected to each other. Further, The SOU terminal of the light emitting chip C2 and the SIN terminal of the light emitting chip C3 are connected to each other. Furthermore, the SOU terminal of the light emitting chip C3 and the SIN terminal of the light emitting chip C4 are connected to each other. The SOU terminal of the light emitting chip C4 is not connected.

As described above, the four light emitting chips C1 to C4 are linked in such a manner that the SOU terminal of the former light emitting chip C and the SIN terminal of the latter light emitting chip C are connected to each other. In other words, the SIN terminals and the SOU terminals are terminals used for linking multiple light emitting chips C.

On the other hand, in the light emitting chip group CG2 (the light emitting chips C5 to C8), the light emitting chips are connected from the light emitting chip C8 to the light emitting chip C5, i.e., in the reverse order to those of the light emitting chip group CG1 (the light emitting chips C1 to C4). The SIN terminal and the φ2 terminal of the light emitting chip C8 are connected to each other, whereby the second transfer signal φ2 is fed thereto (not shown in the figure). Further, the SOU terminal of the light emitting chip C8 and the SIN terminal of the light emitting chip C7 are connected to each other (not shown in the figure). Furthermore, the SOU terminal of the light emitting chip C7 and the SIN terminal of the light emitting chip C6 are connected to each other (not shown in the figure). Still furthermore, the SOU terminal of the light emitting chip C6 and the SIN terminal of the light emitting chip C5 are connected to each other. The SOU terminal of the light emitting chip C5 is not connected.

As shown in FIG. 3, the last light emitting chip C4 of the light emitting chips connected in series through the SIN and SOU terminals in the light emitting chip group CG1, and the adjacent light emitting chip C5 belonging to the light emitting chip group CG2 are arranged so as to face each other. Thus, the scan directions (see FIG. 5 described later) of the light emitting points (light emitting thyristors) of the light emitting chips C4 and C5 are opposite to each other. In other words, in FIG. 3, the light emitting points (light emitting thyristors) of the light emitting chip C4 are scanned from left to right, whereas the light emitting points (light emitting thyristors) of the light emitting chip C5 are scanned from right to left. Therefore, if there is a lag in the light-up (light emitting) timing of the light emitting point (light emitting thyristor) at the borderline portion between the light emitting chip C4 and the light emitting chip C5, the image formed at the borderline portion between the light emitting chip C4 and the light emitting chip C5 involves the positional displacement in the second scan direction (see FIG. 3). As a result, stripe-shaped unevenness is formed in the second scan direction at the borderline portion between the light emitting chip C4 and the light emitting chip C5.

For this reason, the light-up (light emitting) timings of the light emitting chip C4 and the light emitting chip C5 are adjusted by making connections as described above. This suppresses the positional displacement in the second scan direction (see FIG. 3) of the image formed at the borderline portion between the light emitting chip C4 and the light emitting chip C5, and thereby improves the image quality.

The same applies to the cases with the other light emitting chip groups CG3 to CG10.

Note that, in the light emitting chip group CG1, the light emitting chip C1 is arranged so as to face the light emitting chip C2, the light emitting chip C2 is arranged so as to face the light emitting chip C3, and the light emitting chip C3 is arranged so as to face the light emitting chip C4 as shown in FIG. 3, whereby the scan directions of the light emitting points (light emitting thyristors) are opposite to each other. Therefore, as in the above case, each of the borderlines between the light emitting chips C involves the positional displacement in the second scan direction. To avoid this, if the light emitting unit 63 is formed of two types of the light emitting chips: a light emitting chip CA that has the same configuration as the light emitting chip C described above, and a light emitting chip CB that has a configuration which is formed by inverting the configuration of the light emitting chip CA in the longitudinal direction of the chip, the positional displacement in the second scan direction at the borderlines between the light emitting chips C may be suppressed.

More specifically, when the light emitting chip CA is used for the light emitting chip C1 in FIG. 3, the light emitting points (light emitting thyristors) of the light emitting chip C1 are arrayed along the longitudinal side of the light emitting chip C1 on the upper part (in FIGS. 3 and 4), and light-up is controlled from left to right. When the light emitting chip CB is used for the light emitting chip C2, the light emitting points (light emitting thyristors) of the light emitting chip C2 are arrayed along the longitudinal side of the light emitting chip C2 on the lower part (in FIGS. 3 and 4), and light-up is controlled from left to right (in FIGS. 3 and 4). As a result, light-up of the light emitting chip C1 and the light emitting chip C2 is controlled in the continuous manner from the light emitting point at the right end of the light emitting chip C1 to the light emitting point at the left end of the light emitting chip C2, whereby the positional displacement in the second scan direction may be suppressed. Similarly, it is only necessary to use the light emitting chip CA for the light emitting chip C3 and to use the light emitting chip CB for the light emitting chip C4.

In contrast to the light emitting chips of the light emitting chip group CG1, as for the light emitting chips C5, C6, C7 and C8 of the light emitting chip group CG2, the light emitting chip CB is used for each of the light emitting chips C5 and C7 while the light emitting chip CA is used for each of the light emitting chips C6 and C8. In this way, light-up is controlled in the order from the light emitting point at the right end of the light emitting chip C8 (not illustrated) to the light emitting point at the left end of the light emitting chip C5.

As described above, two light emitting chip groups CG are regarded as a pair, and the light emitting chips CA and the light emitting chips CB are sorted for these paired chip groups, whereby the positional displacement in the second scan direction may be suppressed.

It should be noted that the light emitting chip CB has the configuration which is formed by inversing the light emitting chip CA in the longitudinal direction of the chip, and functions in the same way as the light emitting chip CA. Hereinafter, the light emitting chip CA and the light emitting chip CB are not distinguished from each other and referred to as “light emitting chips C.”

As described above, multiple light emitting chips C are linked together and formed as a group, and thus each group has a single light-up control signal φJ and a single light-up signal φI. In this way, both the number of the light-up control signal lines 108 and the number of the light-up signal lines 109 may be reduced to the lower number (10) than the number of the light emitting chips C (40).

As has been described above, the reference electric potential Vsub and the power supply electric potential Vga are supplied commonly, and the first transfer signal φ1 and the second transfer signal φ2 are transmitted commonly to all the light emitting chips C (C1 to C40) in the light emitting device 65. In addition, the common light-up signal φI and memory signal φm are transmitted to the light emitting chips C belonging to the same group, whereas the different light-up control signal φI and memory signal φm are transmitted for the light emitting chips C belonging to the different groups.

As described later, the light emitting chips C belonging to the same group are controlled in such a manner that the light emitting points of the light emitting chips C belonging thereto light up (emit light) in order. Further, the light emitting points of the light emitting chips C belonging to the different groups are controlled in such a manner that the light emitting points light up (emit light) in parallel.

For example, as for the light emitting chip C1 and the light emitting chip C2 belonging to the light emitting chip group CG1, light-up (light emitting) control is performed first on the light emitting points of the light emitting chip C1, and then light-up (light emitting) control is performed on the light emitting points of the light emitting chip C2. However, as for the light emitting chip C1 belonging to the light emitting chip group CG1 and the light emitting chip C8 belonging to the light emitting chip group CG2, light-up (light emitting) control is performed in parallel for each of the light emitting points. It should be noted that a series of operations for lighting up or lighting out a light emitting point of a light emitting chip C are referred to as “light-up control.”

FIG. 5 is a diagram for explaining a circuit configuration of the light emitting chip C, which is a self-scanning light emitting device array (SLED) chip. Note that, although the light emitting chip C1 is described as an example here, the other light emitting chips C2 to C40 have the same configuration as the light emitting chip C1.

The light emitting chip C1 (C) includes a transfer thyristor array (switch element array) including transfer thyristors T1, T2, . . . , T128 that are arrayed on a board 80 in the first scan direction in line, a memory thyristor array including memory thyristors M1, M2, . . . , M128 that are arrayed similarly in the first scan direction in line, and a light emitting thyristor array (light emitting element array) including light emitting thyristors L1, L2, . . . , L128 that are an example of light emitting elements arrayed similarly in the first scan direction in line.

If the transfer thyristors T1, T2, . . . , T128 are not distinguished from each other, they are referred to as “transfer thyristors T.” Similarly, if the memory thyristors M1, M2, . . . , M128 are not distinguished from each other, they are referred to as “memory thyristors M.” If the light emitting thyristors L1, L2, . . . , L128 are not distinguished from each other, they are referred to as “light emitting thyristors L.”

It should be noted that the above-mentioned thyristors (the transfer thyristors T, the memory thyristors M and the light emitting thyristors L) are semiconductor devices each including three terminals: an anode terminal, a cathode terminal, and a gate terminal.

Additionally, the light emitting chip C1 (C) includes coupling diodes Dc1, Dc2, . . . , Dc127 that each connect a pair of the transfer thyristors T1, T2, . . . , T128 in the numerical order. The light emitting chip C1 (C) further includes connection diodes Dm1, Dm2, . . . , Dm128.

In addition, the light emitting chip C1 includes power supply wire resistances Rt1, Rt2, . . . , Rt128, power supply wire resistances Rm1, Rm2, . . . , Rm128, and resistances Rn1, Rn2, . . . , Rn128.

Similarly to the transfer thyristors T, if the coupling diodes Dc1, Dc2, . . . , Dc127, the connection diodes Dm1, Dm2, . . . , Dm128, the power supply wire resistances Rt1, Rt2, . . . , Rt128, the power supply wire resistances Rm1, Rm2, . . . , Rm128, the resistances Rn1, Rn2, . . . , Rn128 are not distinguished from each other, they are referred to as “coupling diodes Dc,” “connection diodes Dm,” “power supply wire resistances Rt,” “power supply wire resistances Rm,” and “resistances Rn,” respectively.

Herein, as an example, the number of the transfer thyristors T in the transfer thyristor array is set to be 128. The number of the memory thyristors M and the number of the light emitting thyristors L are 128 as well. Similarly, the numbers of the connection diodes Dm, the power supply wire resistances Rt and Rm, and the resistances Rn are 128. However, the number of the coupling diodes Dc is 127, which is lower than the number of the transfer thyristors T by one.

Furthermore, the light emitting chip C1 (C) includes one start diode Ds.

Note that, in FIG. 5, the transfer thyristors T1, T2, . . . , T128 are arrayed in the numerical order from the left side, such as T1, T2, . . . , T128. Similarly, the memory thyristors M1, M2, . . . , M128 and the light emitting thyristors L1, L2, . . . , L128 are arrayed in the numerical order from the left side in FIG. 5. Further, the coupling diodes Dc1, Dc2, . . . , and Dc127, the connection diodes Dm1, Dm2, . . . , Dm128, the power supply wire resistances Rt1, Rt2, . . . , Rt128, the power supply wire resistances Rm1, Rm2, . . . , Rm128, and the resistances Rn1, Rn2, . . . , Rn128 are arrayed similarly in the numerical order from the left side in FIG. 5.

Next, an electrical connection among the elements of the light emitting chip C1 (C) will be described.

The anode terminals of the transfer thyristors T1, T2, . . . , T128, the anode terminals of the memory thyristors M1, M2, . . . , M128, and the anode terminals of the light emitting thyristors L1, L2, . . . , L128 are connected to the board 80 of the light emitting chip C1 (C) (anode common). The anode terminals are connected to the power supply line 103 (see FIG. 4) via the Vsub terminal provided on the board 80. The reference electric potential Vsub is supplied to the power supply line 103.

Gate terminals Gt1, Gt2, . . . , Gt128 of the transfer thyristors T1, T2 . . . , T128 are connected to a power supply wire 71 via the power supply wire resistances Rt1, Rt2, . . . , Rt128 provided so as to correspond to the transfer thyristors T1, T2 . . . , T128. The power supply wire 71 is connected to the Vga terminal. The Vga terminal is connected to the power supply line 104 (see FIG. 4), whereby the power supply electric potential Vga is supplied thereto.

The cathode terminals of the odd-numbered transfer thyristors T1, T3, . . . , T127, starting from the transfer thyristor T1, along the transfer thyristor array are connected to a first transfer signal wire 72. The first transfer signal wire 72 is connected to the φ1 terminal as the input terminal of the first transfer signal φ1. The φ1 terminal is connected to the first transfer signal line 105 (see FIG. 4) via the electric current regulation resistance R1, whereby the first transfer signal φ1 is fed thereto.

In contrast, the cathode terminals of the even-numbered transfer thyristors T2, T4, . . . , T128 are connected to a second transfer signal wire 73 along the transfer thyristor array. The second transfer signal wire 73 is connected to the φ2 terminal as the input terminal of the second transfer signal φ2. The φ2 terminal is connected to the second transfer signal line 106 via the electric current regulation resistance R2, whereby the second transfer signal φ2 is fed thereto.

The cathode terminals of the memory thyristors M1, M2, . . . , M128 are connected to a memory signal wire 74 via the resistances Rn1, Rn2, . . . , Rn128 provided so as to correspond thereto. The memory signal wire 74 is connected to the φm terminal as the input terminal of the memory signal φm. The φm terminal is connected to the memory signal line 107 (the memory signal line 107_1 in the case of the light emitting chip C1) (see FIG. 4), whereby the memory signal φm1 is fed thereto.

Each of the gate terminals Gt1, Gt2, . . . , Gt128 of the transfer thyristors T1, T2, . . . , T128 is connected, via the corresponding one of the connection diodes Dm1, Dm2, . . . , Dm128, to each of the gate terminals Gm1, Gm2, . . . , Gm128 of the memory thyristors M1, M2, . . . , M128 having the same number with a one-to-one relationship. In other words, the anode terminals of the connection diodes Dm1, Dm2, . . . , Dm128 are connected to the respective gate terminals Gt1, Gt2, . . . , Gt128 of the transfer thyristors T1, T2, . . . , T128 while the cathode terminals of the connection diodes Dm1, Dm2, . . . , Dm128 are connected to the respective gate terminals Gm1, Gm2, . . . , Gm128 of the memory thyristors M1, M2, . . . , M128.

If the gate terminals Gt1, Gt2, . . . , Gt128 and the gate terminals Gm1, Gm2, . . . , Gm128 are not distinguished from each other, they are referred to as “gate terminals Gt” and “gate terminals Gm,” respectively.

The connection diode Dm is connected in such a manner that an electric current flows from the gate terminal Gt of the transfer thyristor T to the gate terminal Gm of the memory thyristor M.

In addition, the gate terminals Gm1, Gm2, . . . , Gm128 of the memory thyristors M1, M2, . . . , M128 are connected to the power supply wire 71 via the power supply wire resistances Rm1, Rm2, . . . , Rm128 provided so as to correspond to the memory thyristors M1, M2, . . . , M128.

The coupling diodes Dc1, Dc2, . . . , Dc127 interconnect pairs each formed of two of the gate terminals Gt1, Gt2, . . . , Gt128 of the transfer thyristors T1, T2, . . . , T128 in the numerical order. In other words, the coupling diodes Dc1, Dc2, . . . , Dc127 are serially connected, while the gate terminals Gt1, Gt2, . . . , Gt128 are sequentially interposed therebetween. The direction of the coupling diode Dc1 is set in such a manner that an electric current flows from the gate terminal Gt1 to the Gate terminal Gt2. The same applies to the other coupling diodes Dc2, Dc3, . . . , Dc127.

The cathode terminals of the light emitting thyristors L1, L2, . . . , L128 are connected to a light-up signal wire 75 and connected to the φI terminal. The φI terminal is connected to the light-up signal line 109 (the light-up signal line 109_1 in the case of the light emitting chip C1), whereby the light-up signal φI (the light-up signal φI1 in the case of the light emitting chip C1) (see FIG. 4) is fed thereto. Note that the light-up signals φI1 to φI10 are fed, for the respective groups, to the φI terminals of the other light emitting chips C2 to C40.

Gate terminals G11, G12, . . . , G1128 of the light emitting thyristors L1, L2, . . . , L128 are connected to the gate terminals Gm1, Gm2, . . . , Gm128 of the memory thyristors M1, M2, . . . , M128 having the same number with a one-to-one relationship, respectively.

Moreover, the gate terminal Gt1 of the transfer thyristor T1, which is located on one end side of the transfer thyristor array, is connected to the cathode terminal of the start diode Ds. The anode terminal of the start diode Ds is connected to the SIN terminal.

On the other hand, the gate terminal Gt128 of the transfer thyristor T128, which is located on the other end side of the transfer thyristor array, is connected to the SOU terminal.

As shown in FIG. 4, in the light emitting chip group CG1, the SOU terminal of the light emitting chip C1 and the SIN terminal of the light emitting chip C2 are connected to each other. The SOU terminal of the light emitting chip C1 is connected to the gate terminal Gt128. The SIN terminal of the light emitting chip C2 is connected to the anode terminal of the start diode Ds. The start diode Ds has the same structure and feature as the coupling diodes Dc. For this reason, the connection between the SOU terminal of the light emitting chip C1 and the SIN terminal of the light emitting chip C2 indicates that the transfer thyristor T1 of the light emitting chip C2 is connected to the transfer thyristor T128 of the light emitting chip C1, and regarded as the transfer thyristor T129 of the light emitting chip C1 following the transfer thyristor T128. In other words, the combination of the light emitting chip C1 and the light emitting chip C2 constitutes a transfer thyristor array, a memory thyristor array, and a light emitting thyristor array each formed of 256 (=128×2) thyristors.

Similarly, four light emitting chips formed of the light emitting chip C1 to the light emitting chip C4 constitute a transfer thyristor array, a memory thyristor array, and a light emitting array each formed of 512 (=128×4) thyristors.

The same applies to the other light emitting chip groups CG (CG2 to CG10).

Next, an operation of the light emitting device 65 will be described.

As shown in FIG. 4, the reference electric potential Vsub and the power supply electric potential Vga are supplied commonly, and the first transfer signal φ1 and the second transfer signal φ2 are transmitted commonly to all the light emitting chips C (C1 to C40) constituting the light emitting unit 63 of the light emitting device 65. The same light-up signal φI and memory signal φm are transmitted to the light emitting chips C belonging to the same group, whereas the different light-up signal φI and memory signal φm are transmitted to the light emitting chips C belonging to the different groups.

As mentioned above, the light emitting chips C belonging to the same group are substantially the same as a single light emitting chip including the light emitting chips C interconnected with each other in the numerical order.

As will be described later, as for the light emitting chips C belonging to the same group, light-up control is performed in the order that the connection of the SOU terminal to the SIN terminal is made. As for the light emitting chips C belonging to the different groups, light-up control is performed in parallel.

For example, as for the light emitting chip C1 and the light emitting chip C2 belonging to the light emitting chip group CG1, light-up control is performed first on the light emitting points of the light emitting chip C1, and then light-up control is performed on the light emitting points of the light emitting chip C2. However, as for the light emitting chip C1 belonging to the light emitting chip group CG1 and the light emitting chip C8 belonging to the light emitting chip group CG2, light-up control is performed in parallel.

As described above, the operation of the light emitting unit 63 of the light emitting device 65 may be grasped only by explaining the operation of the light emitting chip C1. Therefore, the light emitting chip C1 is taken as an example for explaining the operation of the light emitting chips C.

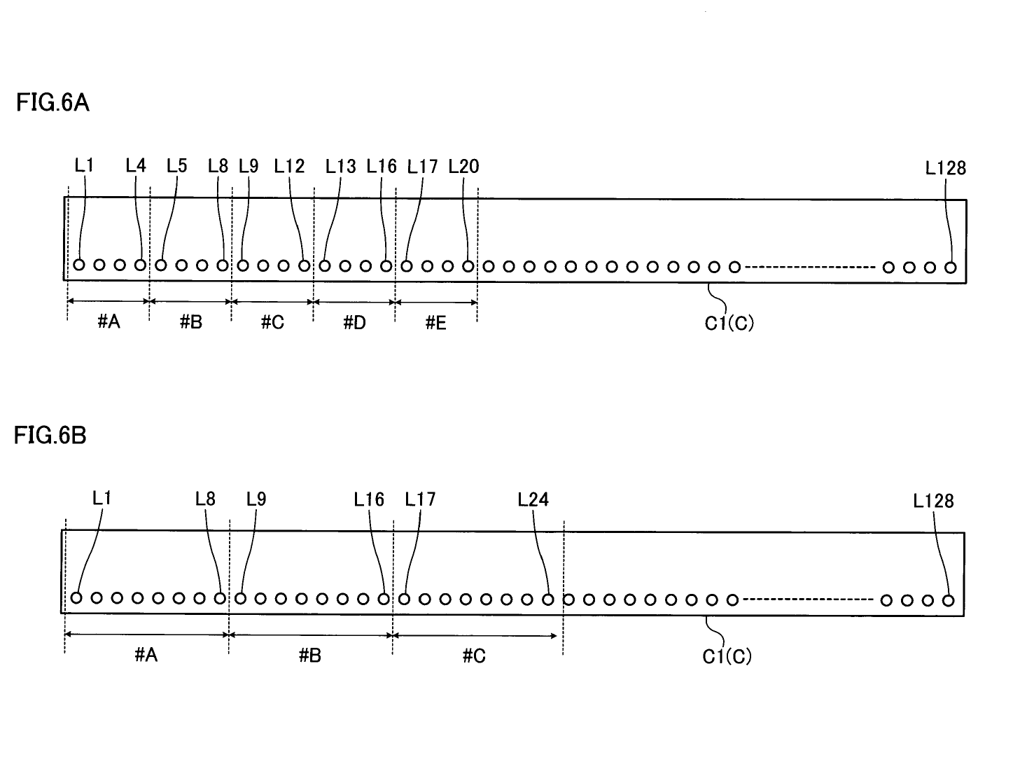

FIGS. 6A and 6B are views for explaining the outline of the light-up control on the light emitting chip C1 (C).

In the present exemplary embodiment, in the light emitting chip C1 (C), light emitting points are divided into groups each having the predetermined number of light emitting points and are caused to light up for each group. The first step of the light-up control is to memorize (latch) in turn the positions (numbers) of the light emitting thyristors L to light up. The second step of the light-up control is to cause these memorized light emitting thyristors L to light up (emit light) by feeding the light-up signal φI thereto. The number of the light emitting points to light up is an integer equal to or lower than the maximum value, i.e., the total number of the light emitting points included in the group.

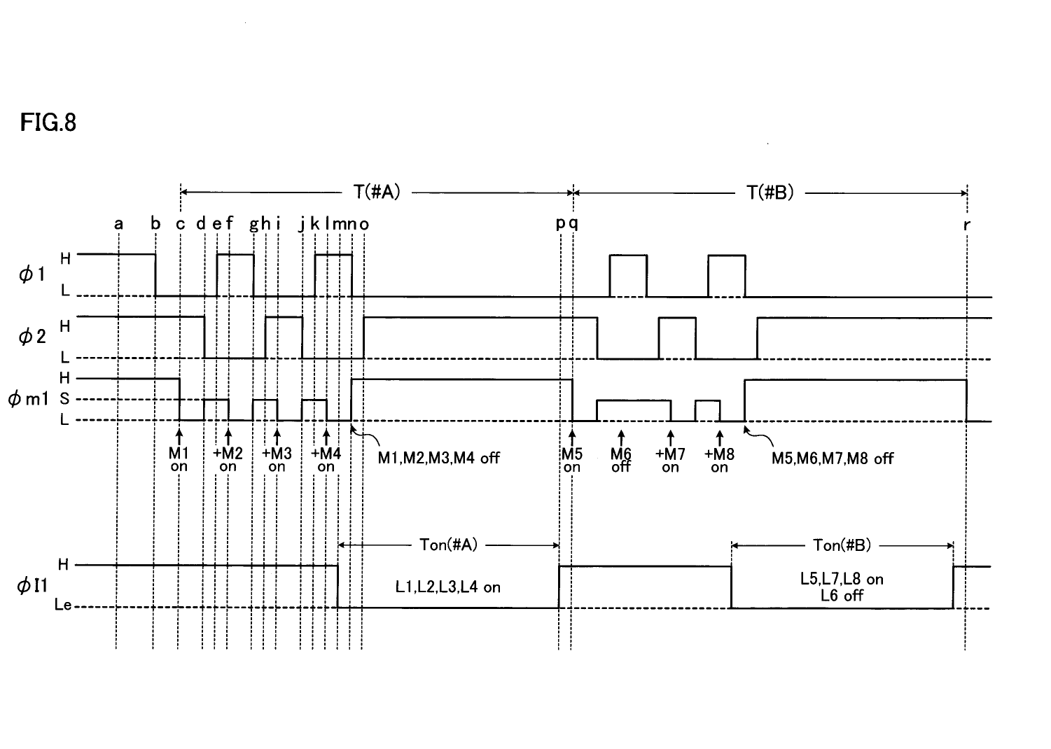

FIG. 6A illustrates a case where the four light emitting thyristors L, at a maximum, emit light simultaneously. To begin with, in FIG. 6A, light-up control is performed on a group #A including the four light emitting thyristors L1 to L4 that are indicated by #A and counted from the left end of the light emitting chip C1 (C) (period T (#A) in FIG. 8 described later). Next, light-up control is performed on a group #B including the adjacent four light emitting thyristors L5 to L8 that are indicated by #B (similarly, period T (#B) in FIG. 8 described later). Then, light-up control is performed on a group #C including the four light emitting thyristors L9 to L12 that are indicated by #C. Similarly, light-up control is performed in turn on a group #D including the adjacent four light emitting thyristors L13 to L16 that are indicated by #D.

In other words, in the present exemplary embodiment, light-up control is performed in time series from the groups #A, #B and so on, and then, in each group (grouping) of the groups #A, #B and so on, the multiple light emitting thyristors L are caused to light up simultaneously at the above-mentioned second step. Note that depending on image data, the number of the light emitting thyristors L caused to light up simultaneously may be single or 0 (zero).

It should be noted that, in the present exemplary embodiment, an event where the multiple light emitting thyristors L are caused to light up simultaneously indicates that the multiple light emitting thyristors L are caused to light up by feeding the light-up signal φI thereto (more specifically, at timing when “H” changes to “Le” described later).

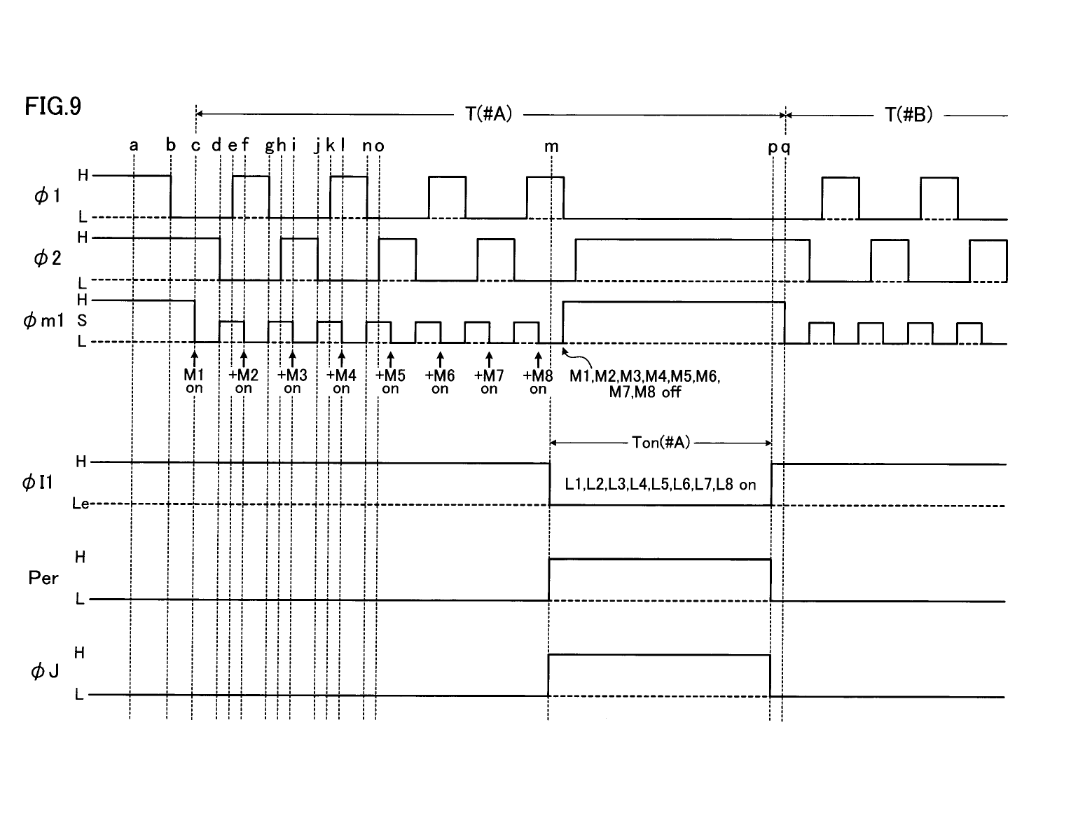

FIG. 6B illustrates a case where light emitting thyristors L, eight at the maximum, emit light simultaneously. To begin with, in FIG. 6B, light-up control is performed on the group #A including the eight light emitting thyristors L1 to L8 that are indicated by #A and counted from the left end of the light emitting chip C1 (C) (period T (#A) in FIG. 9). Next, light-up control is performed on the group #B including the adjacent eight light emitting thyristors L9 to L16 that are indicated by #B (period T (#B) in FIG. 9). Similarly, light-up control is performed in turn on the group #C that is indicated by #C.

Although the number of light emitting thyristors in each of the groups #A, #B and so on, where light-up control is performed, is different, light-up control in FIG. 6B is performed in time series from the groups #A, #B and so on, and multiple light emitting thyristors L are caused to light up simultaneously at the above-mentioned second step, similarly to FIG. 6A. Note that depending on image data, the number of light emitting thyristors L to be caused to light up simultaneously may be single or 0.

In the light emitting chip C, the light emitting amounts (light exposure amounts) may differ among the light emitting thyristors L. Therefore, an average light exposure amount of the light emitting thyristors L is calculated for each group. Then, light exposure amount correction values (correction values), such as difference and proportion between the average light exposure amount and a predetermined referential light exposure amount (reference light exposure amount), are stored in the LUT 102 and are used for correcting the light exposure amount.

In other words, in a case where the interval of the light emitting thyristors L is a spatial frequency (resolution) that is not recognized by eyes of human, the human eyes do not recognize (resolve) differences in the light exposure amount among the light emitting thyristors L. Therefore, correction of the light exposure amount is not necessary for each light emitting thyristor L, and the correction is to be performed for each group. For example, in a case where the light exposure amount of the light emitting thyristors L belonging to a group is 90% of the reference light exposure amount, the light exposure amount of each light emitting thyristor L belonging to the group is to be multiplied by 10/9 (correction value).

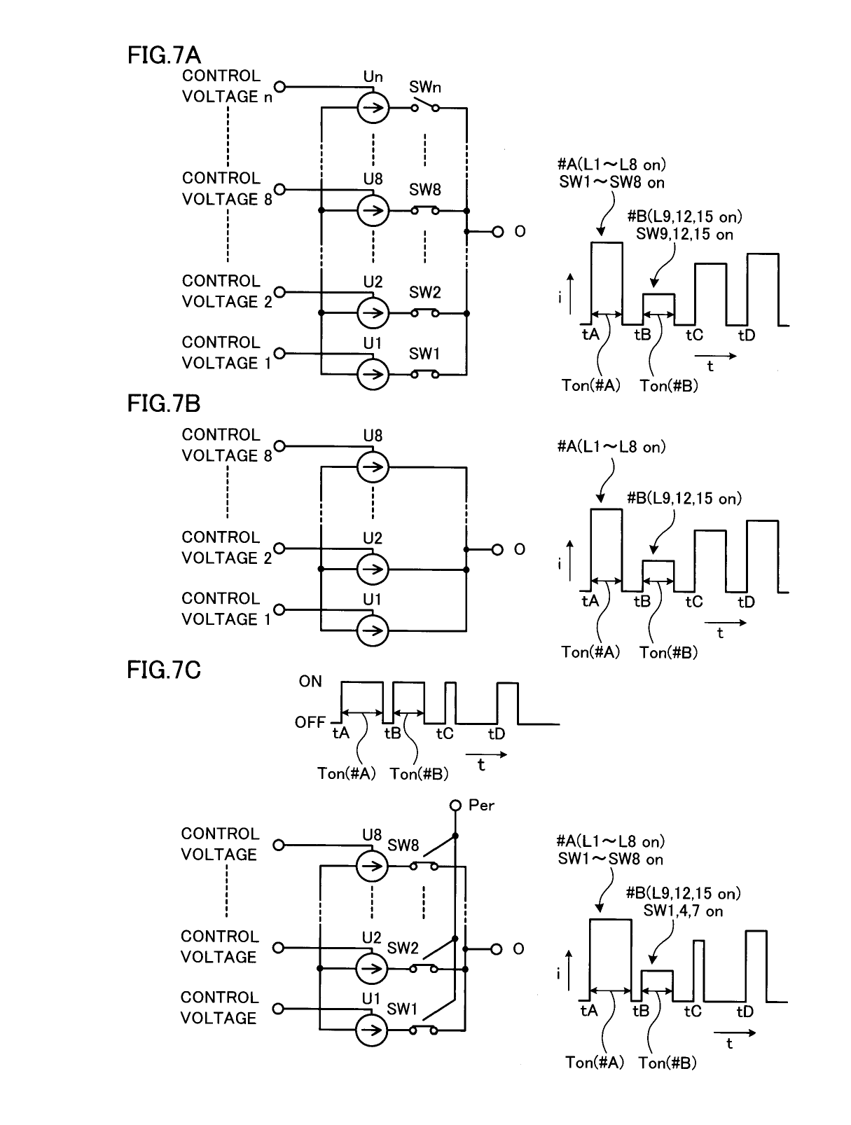

FIGS. 7A to 7C illustrate methods for correcting, for each group, the light exposure amount of the light emitting thyristors L belonging to a group. In the present exemplary embodiment, an electric current supply (electric current supply unit U) supplies an electric current to the light emitting thyristors L for emitting light. Note that although an electric current may be drawn, an event where an electric current is supplied in the description indicates that an electric current is supplied or that an electric current is drawn. The electric current supply unit U is a power supply that supplies a predetermined electric current. As described later, the electric current supply unit U may be formed of a current mirror circuit and the like formed of a combination of multiple MOS transistors. In the MOS transistor, an electric current flowing through the MOS transistor is controlled by using a voltage (gate voltage) applied to a gate terminal. Accordingly, also in the electric current supply unit U formed of the current mirror circuit and the like, an electric current to be supplied is controlled by using a voltage (control voltage) applied to a gate terminal of the MOS transistor. By finely changing the control voltage, the electric current to be supplied by the electric current supply unit U is to be finely changed. It should be noted that there are multiple electric power supply units U, which are referred to as the electric current supply units U1, U2, and so on if distinguished from each other.

FIG. 7A illustrates a method (method 1) where the same number (n in this case) of the electric current supply units U (U1 to Un) as the number of the light emitting points (light emitting thyristors L) constituting the light emitting unit 63 of the light emitting device 65 are provided.

The light exposure amount of each light emitting point constituting the light emitting unit 63 is measured in advance, and the correction value thereof for the reference light exposure amount is stored in the LUT 102.

Control voltages 1 to n are supplied to the electric current supply units U1 to Un, respectively. Here, the control voltages 1 to n set the electric current so that each light emitting point has the corrected light exposure amount. Moreover, the electric current supply units U1 to Un are concentrated into an electric current supply terminal O via switches SW1 to SWn that are provided so as to correspond thereto.

For example, in order to cause all the light emitting thyristors L1 to L8 belonging to the group #A to light up, the switches SW1 to SW8 corresponding to the electric current supply units U1 to U8 are turned on at a time point tA in a timing chart illustrated on the right side of FIG. 7A. Accordingly, the sum of electric currents flowing through the light emitting thyristors L1 to L8 is outputted to the electric current supply terminal O. The electric current units U1 to U8 correspond to the light emitting thyristors L1 to L8, respectively, and output the electric current values so that the light exposure amount becomes the light exposure amount corrected with the correction value stored in the LUT 102. The sum of these electric currents is outputted from the electric current supply terminal O.

Next, the electric current flowing through the light emitting thyristors L1 to L8 are turned off, and then, for example, the light emitting thyristors L9, L12 and L15 belonging to the group #B are caused to light up. In this case, the switches SW9, SW12, and SW15 corresponding to the electric current supply units U9, U12 and U15 are turned on at a time point tB. Accordingly, the sum of electric currents flowing through the light emitting thyristors L9, L12 and L15 is outputted from the electric current supply terminal O.

The light-up period Ton (#A) starting from the time point tA, the light-up period Ton (#B) starting from the time point tB, and the like of the light emitting points (light emitting thyristors L) are the same.

By this configuration, the light exposure amounts of light emitting thyristors L may be corrected for each group.

In the method 1, electric currents outputted from the electric current supply units U1 to Un are switched by turning on or off the switches SW 1 to SWn, whereby the switching of the electric current outputted from the electric current supply terminal O is performed quickly. However, because the same number of electric current supply units U1 to Un as the number (n) of the light emitting points (light emitting thyristors L) of the light emitting unit 63 are to be provided, the circuit size is large.

FIG. 7B illustrates a method (method 2) where the control voltage for the electric current supply unit U is switched depending on the light exposure amount of the light emitting point (light emitting thyristor L).

Similarly to the method 1, the light exposure amounts of the light emitting points constituting the light emitting unit 63 are measured in advance, and the correction values thereof for the reference light exposure amount is stored in the LUT 102.

Herein, the electric current supply units U are provided so as to have the same number as the number of light emitting points to be caused to light up simultaneously. For example, eight electric current supply units U1 to U8 are provided if the eight light emitting thyristors L, at a maximum, emit light simultaneously. As a control voltage 1 to a control voltage 8, the control voltage is applied thereto so that the light emitting points to be caused to light up simultaneously each have the corrected light exposure amount. Note that the switches (switches SW1 to SW8 in FIG. 7A) may not be provided.

For example, if the light emitting thyristors L1 to L8 belonging to the group #A are caused to light up, the control voltage 1 to the control voltage 8 are applied to the electric current supply units U1 to U8 at the time point to of the timing chart in the right side of FIG. 7B, respectively. In other words, as the control voltage 1 of the electric current supply unit U1, a voltage that gives the corrected light exposure amount to the light emitting thyristor L1 is applied thereto on the basis of the correction value stored in the LUT 102. As the control voltage 2 of the electric current supply unit U2, a voltage that gives the corrected light exposure amount to the light emitting thyristor L2 is applied thereto. Similarly, as the control voltages 3 to 8 of the electric current supply units U3 to U8, voltages that give the corrected light exposure amounts to the light emitting thyristors L3 to L8 are applied thereto, respectively. Accordingly, the sum of electric currents to flow through the light emitting thyristors L1 to L8 is outputted from the electric current supply terminal O.

Next, the electric currents to flow through the light emitting thyristors L1 to L8 are turned off, and then, for example, the light emitting thyristors L9, L12 and L15 belonging to the group #B are caused to light up. In such a case, the control voltage 1, the control voltage 4, and the control voltage 7 are applied to the electric current units U1, U4 and U7, respectively, at the time tB. At this time, as the control voltage 1 of the electric current supply unit 1, a voltage that gives the corrected light exposure amount to the light emitting thyristor 9 is applied thereto on the basis of the correction value stored in the LUT 102. As the control voltage 4 of the electric current supply unit U4, a voltage that gives the corrected light exposure amount to the light emitting thyristor L12 is applied thereto. Similarly, as the control voltage 7 of the electric current supply unit U7, a voltage that gives the corrected light exposure amount to the light emitting thyristor L15 is applied thereto. Accordingly, the sum of electric currents to flow through the light emitting thyristors L9, L12 and L15 is outputted from the electric current supply terminal O.

The light-up period Ton (#A) starting from the time point tA, the light-up period Ton (#B) starting from the time point tB, and the like of each light emitting point (light emitting thyristor L) are the same.

As described above, in the method 2, voltages that are set as the control voltage 1 to control voltage 8 are switched.

The method 2 may also correct the light exposure amounts of the light emitting thyristors L for each group.

Because, in the method 2, the number of the electric current units U is set to be the same as the number of the light emitting thyristors L to be caused to light up simultaneously, the number of the electric current supply units U is lower than that of the method 1. Further, in the method 2, the number of the electric current units U may be reduced. For example, if the eight light emitting thyristors L are caused to light up simultaneously, the number of the electric current supply units U may be four (electric current units U1 to U4). In this case, the control voltage 1 is set at a voltage for supplying the sum of electric currents that give the corrected light exposure amount to the light emitting thyristor L1 and the corrected light exposure amount to the light emitting thyristor L2. Similarly, the control voltage 2 is set at a voltage for supplying the sum of electric currents that give the corrected light exposure amount of the light emitting thyristor L3 and the light exposure amount of the light emitting thyristor L4. The same applies to the other electric current supply units U3 and U4. Note that the combination of the light emitting thyristors L for this case may be changed.

Moreover, in the method 2, the number of electric current supply units U may be 1 (electric current supply unit U1). If all the light emitting thyristors L1 to L8 belonging to the group #A are caused to light up simultaneously, the control voltage 1 is set at a voltage for supplying the sum of electric currents that give the corrected light exposure amounts to the light emitting thyristors L1 to L8.

In the method 2, the number of the electric current supply units U may be the same as the number of the light emitting points to be caused to light up simultaneously or may be lower than that (or may be 1), and therefore the number of the electric current supply units U is relatively low. However, because the control voltage is switched, the relationship between the electric current outputted from the electric current supply unit U and the control voltage needs to be calculated in advance. The correction of the light exposure amount of the light emitting thyristor L requires a fine setting of the control voltage. In order to control the control voltage quickly and finely, many circuits (buffer circuits) each of which supplies multiple different voltages are provided, and switching is to be performed. In particular, if a MOS transistor circuit is to generate the multiple different voltages, the circuit size may become larger.

FIG. 7C illustrates a method (method 3) where the light-up period Ton is switched instead of changing the control voltages of the electric current supply units U. Similarly to the method 2, the number of the electric current supply units U is the same as the number of the light emitting points to be caused to light up simultaneously. The eight electric current supply units U1 to U8 are provided on condition that the eight light emitting thyristors L, at a maximum, are caused to light up. The control voltage of the same electric potential is applied to the electric current supply units U1 to U8. The electric current supply units U1 to U8 are concentrated into the electric current supply terminal O via the switches SW1 to SW8 provided so as to correspond thereto. A light-up period signal Per is fed to the switches SW1 to SW8.

Similarly to the methods 1 and 2, the light exposure amounts of the light emitting points constituting the light emitting unit 63 are measured in advance. For each of the groups (#A, #B and so on), the light-up periods Ton (#A), Ton (#B) and so on for obtaining, as the predetermined light exposure amount (reference light exposure amount), the average light exposure in a case of causing all the light emitting thyristors L belonging to each group to light up, are calculated and stored in the LUT 102.

Note that, for each of the groups (#A, #B and so on), the average light exposure amount in the case of causing all the light emitting thyristors L belonging to each group to light up may be calculated in advance, and then the light-up periods Ton (#A), Ton (#B) and so on that give the predetermined light exposure amount (reference light exposure amount) may be calculated, and stored in the LUT 102. Note that the stripe caused by the unevenness in the light exposure amount is noticeable in the image of a half tone. In this case, a half of the group is caused to light up to obtain the average light exposure amount.

For example, if all the light emitting thyristors L1 to L8 belonging to the group #A are caused to light up, the switches SW1 to SW8 corresponding to the electric current supply units U1 to U8 are switched to an on state, at the time point to of the timing chart illustrated on the right side of FIG. 7C, in the light-up period Ton (#A) that is read from the LUT 102 for the group #A. Because the same control voltage is applied to the electric current units U, the electric current supply units U1 to U8 output the same unit electric current Iunit. Therefore, in the light-up period Ton (#A), 8 times of the unit electric current Iunit is outputted from the electric current supply terminal O. The start time and the end time of the light-up period Ton (#A) are set by the light-up period signal Per.

In addition, if the light emitting thyristors L9, L12 and L15 belonging to the group #B, for example, are caused to light up after the light-up period Ton (#A), the switches SW1, SW4 and SW7 corresponding to the electric current supply units U1, U4 and U7 are switched to an on (ON) state in the light-up period Ton (#B) that is read from the LUT 102 for the group #B. Note that since the electric current supply units U1 to U8 output the same unit electric current Iunit, any three electric current supply units U may be turned on.

In other words, the light-up period Ton of the light emitting thyristors L belonging to one group and being caused to light up simultaneously is set on the basis of the correction value stored in the LUT 102. Thus, the average light exposure amount of the light emitting thyristors L belonging to a group may be adjusted to the reference light exposure amount.

As described above, in the method 3, the light-up period Ton is set for each group. Further, because the electric current supply unit U is controlled with the same control voltage, it is not necessary to obtain in advance the relationship between the control voltage and the electric current outputted from each electric current supply unit U.

In addition, it is not necessary to prepare a circuit for supplying multiple different voltages (buffer circuit) in order to supply the control voltage.

Note that the control voltage may be changed in a case where the light exposure amount (pixel density) of all the light emitting points (light emitting thyristors L) constituting the light emitting unit 63 is to be increased or decreased at once. In other words, in the method 3, the unevenness in the light exposure amounts of the light emitting points is corrected by changing the light-up period Ton for each group while the light exposure amount (average light exposure amount) of the entire light emitting unit 63 is adjusted by changing the control voltage to increase or decrease the unit electric current Iunit supplied by the electric current supply units U. In this way, quick control is realized with high control accuracy.

Hence, the method 3 may be employed as a method of correcting, for each group, the light exposure amounts of the light emitting thyristors L belonging to a group. Only the method 3 will be described below.

As described above, the number of the light-up signal wires may be reduced on the basis of the spatial frequency (resolution) that is not recognized by human eyes. Further, in a case where the number of light-up signal wires is not reduced, the light-up period may be shortened by causing the light emitting thyristors L belonging to a group to light up simultaneously, whereby the image is formed quickly.

In addition, the LUT 102 where the correction values are stored may be provided in the signal generating circuit 100 as shown in FIG. 4. Alternatively, the LUT 102 may be provided outside the signal generating circuit 100, such as in the image output control unit 30, and may be supplied together with the image data.

FIG. 8 is a timing chart for explaining operations of the light emitting chip C1. FIG. 8 shows a case where light-up control is performed on the four light emitting thyristors L for each group shown in FIG. 6A. Note that FIG. 8 illustrates only a part of the light emitting thyristors L on which the light-up control is performed, i.e., the four light emitting thyristors L in the group #A and the four light emitting thyristors L in the group #B.

In the period T (#A) in FIG. 8, all the four light emitting thyristors L1 to L4 in the group #A are caused to light up (emit light). In the period T (#B), the light emitting thyristors L5, L7 and L8 of the four light emitting thyristors L5 to L8 in the group #B are caused to light up (emit light) while the light emitting light L6 remains off.

In FIG. 8, passing of time is illustrated in alphabetical order from a time point a to a time point r. Light-up control is performed on the light emitting thyristors L1 to L4 in the group #A in FIG. 6A in the period T (#A) between a time point c to a time point q. Light-up control is performed on the light emitting thyristors L5 to L8 in the group #B in FIG. 6A in the period T (#B) between the time point q to the time point r. Note that although not illustrated in FIG. 8, the period T (#C), in which light-up control is performed on the light emitting thyristors L9 to L12 in the group #C in FIG. 6A, follows the period T (#B). In a case where the light emitting chip C1 includes 128 light emitting thyristors L, light-up control is performed on each group including four of the light emitting thyristors up to L128.

Signal waveforms in the period T (#A), the period T (#B) and so on are repeated in the same manner except for the memory signal φm1 that changes depending on image data. Therefore, only the period T (#A) between the time point c and the time point q is described below. Note that in the period between the time point a and the time point c, the light emitting chip C1 starts to be operated. The signal in the period will be described along with the description on operations.

A description will be given of waveforms of the first transfer signal φ1, the second transfer signal φ2, the memory signal φm1 and the light-up signal φI1 in the period T (#A).

The first transfer signal φ1 has a low-level electric potential (hereinafter, “L”) at the time point c, then the potential thereof changes from “L” to a high-level electric potential (hereinafter, “H”) at a time point e, and changes from “H” to “L” at a time point g. Subsequently, the first transfer signal φ1 changes from “L” to “H” at a time point k, and changes from “H” to “L” at a time point n. Thereafter, the first transfer signal φ1 remains at “L” until the time point q.

The second transfer signal φ2 is “H” at the time point c, then changes from “H” to “L” at a time point d, and changes from “L” to “H” at a time point h. Subsequently, the second transfer signal φ2 changes from “H” to “L” at a time point j and changes from “L” to “H” at a time point o. Thereafter, the second transfer signal φ2 remains at “H” until the time point q.

Here, in the period between the time point c and the time point o, the first transfer signal φ1 and the second transfer signal φ2, when compared with each other, repeat “H” and “L” alternately to each other, and periods in which both signals are set at “L” (e.g., period between the time point d and the time point e and between the time point g and the time point h) are found. The first transfer signal φ1 and the second transfer signal φ2 do not have a period when the potential thereof are set at “H” simultaneously.

The memory signal φm1 changes from “H” to “L” at the time point c and changes from “L” to an electric potential of a memory level (hereinafter, “S”) at the time point d. Note that, although a detailed description will be given later, the memory level “S” is an electric potential between “H” and “L.” Further, the memory level “S” is an electric potential level that maintains the ON state of the memory thyristor M that has been turned on.

The memory signal φm1 changes from “S” to “L” at a time point f and changes from “L” to “S” at the time point g. Further, the memory signal φm1 changes from “S” to “L” at a time point i, then changes from “L” to “S” at the time point j, thereafter changes from “S” to “L” at a time point 1, and changes from “L” to “H” at the time point n. The memory signal φm1 remains at “H” at the time point q.

Here, a description will be given of the relationship between the memory signal φm1 and the first transfer signal φ1 and second transfer signal φ2. When either the first transfer signal φ1 or the second transfer signal φ2 is set at “L,” the memory signal φm1 is set at “L.” For example, the memory signal φm1 is set at “L” in the period between the time point c and the time point d, when the first transfer signal φ1 is set at “L,” and in the period between the time point f and the time point g, when the second transfer signal φ2 is set at “L.”

As will be described later, in the present exemplary embodiment, the light-up signal φI1 is a signal for supplying an electric current to the light emitting thyristor L so that the light emitting thyristor L emits light (lights up).

The light-up signal φI1 is set at “H” at the time point c and changes to a light-up level (hereinafter, “Le”) at a time point m. The light-up signal φI1 changes from “Le” to “H” at a time point p. Then, the light-up signal φI1 remains at “H” at the time point q.

Although the light-up level “Le” will be described later in the description on operations, the light-up level “Le” is an electric potential that may cause the light emitting thyristor L being set ready to light up to light up and is an electric potential between “H” and “L.”

Before the operation of the light emitting chip C1 is described, the fundamental operation of the thyristor (each of the transfer thyristor T, the memory thyristor M, and the light emitting thyristor L) will be described. The thyristor is a semiconductor device including three terminals: an anode terminal, a cathode terminal, and a gate terminal.

In the description below, for example, the reference electric potential Vsub supplied to the anode terminal (Vsub terminal) of the thyristor shown in FIG. 5 may be set at 0 V (“H”) while the power supply electric potential Vga supplied to the Vga terminal is set at −3.3 V (“L”). The thyristor is formed of stacked layers of p-type semiconductor layers and n-type semiconductor layers such as GaAs, and a diffusion electric potential (forward electric potential) Vd of pn junction is set at 1.5 V.

The thyristor is turned on when an electric potential lower than a threshold voltage (i.e., greater in a negative sense) is applied to the cathode terminal. When the thyristor is turned on, the thyristor is set at a state (ON state) in which the electric current flows through the anode terminal and the cathode terminal. Here, the threshold voltage of the thyristor is obtained by subtracting the diffusion electric potential Vd from the electric potential of the gate terminal. Accordingly, if the electric potential of the gate terminal of the thyristor is −1.5 V, the threshold voltage of the thyristor is −3 V. In other words, the thyristor is turned on when a voltage lower than −3 V is applied to the cathode terminal.

After the thyristor is turned on, the gate terminal of the thyristor has a value almost equal to the electric potential of the anode terminal of the thyristor. Because the anode terminal thereof is set at 0 V in this case, the electric potential of the gate terminal is 0 V or around that (hereinafter, regarded as 0 V approximately). Further, the cathode terminal of the thyristor has the diffusion electric potential Vd (−1.5 V in this case).

After the thyristor is turned on, the thyristor maintains the ON state until the electric potential of the cathode terminal reaches an electric potential higher than the electric potential (smaller in a negative sense) necessary for the thyristor to maintain the ON state. In other words, because the electric potential of the cathode terminal of the thyristor is −1.5 V in the ON state, the ON state of the thyristor is maintained after an electric potential that is lower than −1.5 V is applied to the cathode terminal and the electric current necessary to maintain the ON state is supplied.

Note that when the cathode terminal is set at “H” (0 V) and is equal to the same electric potential as the anode terminal, the thyristor is no longer maintain the ON state and turned off (OFF). When the thyristor is turned off, the thyristor is set at a state (OFF state) in which the electric current does not flow through the anode terminal and the cathode terminal. In other words, once the thyristor is set in the ON state, the thyristor maintains a state in which the electric current flows, and the thyristor may not be turned off depending on the electric potential of the gate terminal. As described above, the thyristor has a function to maintain (memorize and store) the ON state. With such a thyristor, the electric potential for maintain the ON state may be lower than the electric potential for turning on the thyristor.

It should be noted that the light emitting thyristor L lights up (emits light) at ON and is put out (does not emit light) at OFF.

With reference to FIG. 5, an operation of the light emitting chip C1 will be described according to the timing chart shown in FIG. 8.

### (Initial State)

The Vsub terminals of the light emitting chips C (C1 to C40) of the light emitting unit 63 are set at the reference electric potential Vsub (0 V) at the time point a in the timing chart shown in FIG. 8. On the other hand, the Vga terminals thereof are set at the power supply electric potential Vga (−3.3 V) (see FIG. 4).

The transfer signal generating unit 120 sets both the first transfer signal φ1 and the second transfer signal φ2 at “H”. The memory signal generating unit 130 sets the memory signals φm (φm1 to φm10) at “H.” The light-up control signal generating unit 110 sets the light-up control signals φJ φJ1 to φJ10) at “H” (see FIG. 4).

By these settings, the first transfer signal line 105 is set at “H,” and the first transfer signal wire 72 of each light emitting chip C is set at “H” via the φ1 terminal of each light emitting chip C of the light emitting unit 63. Similarly, the second transfer signal line 106 is set at “H,” and the second transfer signal wire 73 of each light emitting chip C is set at “H” via the φ2 terminal of each light emitting chip C. Each of the memory signal lines 107 (107_1 to 107_10) is set at “H,” and the memory signal wire 74 of each light emitting chip C is set at “H” via the φm terminal of each light emitting chip C. Further, each of the light-up control signal lines 108 (108_1 to 108_10) is set at “H.” Thereby, the light-up signals φI (φ1 to φ10) outputted from the light-up signal feeding circuits 101 are set at “H” and accordingly the light-up signal lines 109 (109_1 to 109_10) are set at “H.” Then, the light-up signal wire 75 of each light emitting chip C is set at “H” via the 0 terminal of each light emitting chip C.

Next, an operation of the light emitting chip C1 will be described below.

The anode terminals of the transfer thyristors T1, T2, . . . , T128, memory thyristors M1, M2, . . . , M128, and light emitting thyristors L1, L2, . . . , L128 in the light emitting chip C1 are connected to the Vsub terminal, whereby “H” (0 V) is supplied thereto.

On the other hand, the cathode terminals of the odd-numbered transfer thyristors T1, T3, . . . , T127 are connected to the first transfer signal wire 72 that is set at “H,” while the cathode terminals of the even-numbered transfer thyristors T2, T4, . . . , T128 are connected to the second transfer signal wire 73 that is set at “H.” The anode terminal and cathode terminal of each transfer thyristor T are set at “H,” and therefore each transfer thyristor T is in the OFF state.

Similarly, the cathode terminals of the memory thyristors M1, M2, . . . , M128 are connected to the memory signal wire 74 that is set at “H.” The anode terminal and cathode terminal of each memory thyristor M are set at “H,” and therefore each memory thyristor M is in the OFF state.

Furthermore, the cathode terminals of the light emitting thyristors L1, L2, . . . , L128 are connected to receive the light-up signal φI (light-up signal φI1 in the light emitting chip C1) that is set at “H.” The anode terminal and the cathode terminal of each light emitting thyristor L are set at “H,” and therefore each light emitting thyristor L is in the OFF state.

The gate terminal Gt of the transfer thyristor T is set via the power supply wire resistance Rt at the power supply electric potential Vga (“L”: −3.3 V). Thus, the electric potential of the gate terminal Gt becomes “L.”

Similarly, the gate terminal Gm of the memory thyristor M is set via the power supply wire resistance Rm at the power supply electric potential Vga (“L”: −3.3 V). Thus, the electric potential of the gate terminal Gm becomes “L.” Further, the gate terminal Gl of the light emitting thyristor L is connected to the gate terminal Gm of the memory thyristor M. Accordingly, the electric potential of the gate terminal Gl of the light emitting thyristor L also becomes “L.”

The gate terminal Gt1 on the one end side of the transfer thyristor array in FIG. 5 is connected to the cathode terminal of the start diode Ds, as described above. As shown in FIG. 4, the anode terminal of the start diode Ds is connected to the SIN terminal, and the second transfer signal φ2 at “H” is supplied thereto. In the start diode Ds, the cathode terminal is set at “L” (−3.3 V) and the anode terminal is set at “H” (0 V), and therefore a voltage is applied in a forward biased direction (forward bias). The gate terminal Gt1, to which the cathode terminal of the start diode Ds is connected, is set at a value obtained by subtracting the diffusion electric potential Vd (1.5 V) of the start diode Ds from “H” (0 V) of the anode terminal. Thus, in the present exemplary embodiment, the electric potential of the gate terminal Gt1 becomes −1.5 V.

As described above, the threshold voltage of the transfer thyristor T1 is −3 V obtained by subtracting the diffusion electric potential Vd (1.5 V) from the electric potential (−1.5 V) of the gate terminal Gt1.

Note that the gate terminal Gt2 of the transfer thyristor T2 located adjacent to the transfer thyristor T1 is connected to the gate terminal Gt1 via the coupling diode Dc1. Thus, the electric potential of the gate terminal Gt2 of the transfer thyristor T2 is −3 V obtained by subtracting the diffusion electric potential Vd (1.5 V) of the coupling diode Dc1 from the electric potential (−1.5 V) of the gate terminal Gt1. Therefore, the threshold voltage of the transfer thyristor T2 is −4.5 V. Similarly, the gate terminal Gm1 of the memory thyristor M1 (the same applies to the gate terminal Gl1 of the light emitting thyristor L1) is connected to the gate terminal Gt1 via the connection diode Dm1. Thus, the electric potential of the gate terminal Gm1 (gate terminal Gl1) of the memory thyristor M1 is −3 V obtained by subtracting the diffusion electric potential Vd (1.5 V) of the connection diode Dm1 from the electric potential (−1.5 V) of the gate terminal Gt1. Therefore, the threshold voltage of the memory thyristor M1 (the light emitting thyristor L1) is −4.5 V.

Voltages of the gate terminals Gt, Gm and Gl other than the gate terminals Gt1, Gt2, Gm1, and Gl1 are the power supply electric potential Vga (−3.3 V). Therefore, the threshold voltage of the transfer thyristors T, memory thyristors M, and light emitting thyristors L other than the transfer thyristors T1, T2, the memory thyristor M1, and the light emitting thyristor L1, is −4.8 V.

### (Operation Start)

At the time point b, the first transfer signal φ1 changes from “H” (0 V) to “L” (−3.3 V). Accordingly, the transfer thyristor T1, whose threshold voltage is −3 V and higher than “L,” is turned on. The transfer thyristor T2 is not turned on because the threshold voltage thereof is −4.5 V and lower than “L.”Further, the transfer thyristor T3 and others having a larger number than 3, are not turned on because the threshold voltage thereof is −4.8 V.

In other words, only the transfer thyristor T1 is turned on at the time point b.

When the transfer thyristor T1 is turned on, the electric potential of the gate terminal Gt1 becomes the electric potential of the anode terminal, i.e., “H” (0 V), as mentioned above. The electric potential of the cathode terminal (first transfer signal wire 72) is −1.5 V obtained by subtracting the diffusion electric potential Vd (1.5 V) from “H” (0 V) of the electric potential of the anode terminal.

The coupling diode Dc1 is set as a forward bias because the electric potential of the gate terminal Gt1 is “H” and the electric potential of the gate terminal Gt2 is −3 V. Then, the electric potential of the gate terminal Gt2 becomes −1.5 V obtained by subtracting the diffusion electric potential Vd (1.5 V) of the coupling diode Dc1 from the electric potential (0 V) of the gate terminal Gt1. Thus, the threshold voltage of the transfer thyristor T2 is −3 V.

The electric potential of the gate terminal Gt3, which is connected to the gate terminal Gt2 of the transfer thyristor T2 via the coupling diode Dc2, is −3 V calculated similarly to the above. Thus, the threshold voltage of the transfer thyristor T3 is −4.5 V. The electric potential of the gate terminals Gt of the transfer thyristors T having numbers equal to or larger than 4, is −3.3 V of the power supply electric potential Vga, and the threshold voltage thereof is maintained at −4.8 V.

When the transfer thyristor T1 is turned on, the electric potential of the gate terminal Gt1 becomes “H” (0 V). Because the electric potential of the gate terminal Gt1 is “H” (0 V) and the electric potential of the gate terminal Gm1 is −3 V, the connection diode Dm1 has a forward bias. The electric potential of the gate terminal Gm1 and the gate terminal Gl1 becomes −1.5 V obtained by subtracting the diffusion electric potential Vd (1.5 V) of the connection diode Dm1 from “H” (0 V) of the electric potential of the gate terminal Gt1. Therefore, the threshold voltage of the memory thyristor M1 and the light emitting thyristor L1 is −3 V.

Note that the gate terminal Gm2 of the adjacent memory thyristor M2 (the same applies to the gate terminal Gl2 of the light emitting thyristor L2) is −3 V because the coupling diode Dc1 and the connection diode Dm2 are interposed between the gate terminal Gt1 being at “H” (0 V) and the memory thyristor M2. Therefore, the threshold voltage of the memory thyristor M2 (the same applies to the light emitting thyristor L2) is −4.5 V.

The electric potential of the gate terminal Gm of the memory thyristor M (the gate terminal Gl of the light emitting thyristor L), having 3 or a larger number than the memory thyristor M2 (light emitting thyristor L2), is −3.3 V of the power supply electric potential Vga because the electric potential is not influenced by the electric potential of the gate terminal Gt1 being at “H” (0 V). Thus, the threshold voltage of the memory thyristors M (light emitting thyristors L) each having 3 or a larger number is −4.8 V.

It should be noted that because the second transfer signal φ2 is “H” at the time point b, the transfer thyristor T2 and the even-numbered transfer thyristors T having numbers equal to or larger than 4 are not turned on. Further, because the memory signal φm 1 is “H” and the light-up signal φI1 is also “H,” neither the memory thyristors M nor the light emitting thyristors L are turned on.

Thus, the transfer thyristor T1 is in the ON state right after the time point b (after the state of the thyristor or the like is changed due to the change in the electric potential of the signal at the time point b).

### (Operation State)

The memory signal φm1 changes from “H” (0 V) to “L” (−3.3 V) at the time point c. Then, the memory thyristor M1 is turned on because the threshold voltage thereof is −3 V, as mentioned above. The memory thyristor M, having 2 or a larger number, is not turned on because the threshold voltage thereof is lower than “L” (−3.3 V).

In other words, only the memory thyristor M1 is turned on.

When the memory thyristor M1 is turned on, the electric potential of the gate terminal Gm1 becomes “H” (0 V), similarly to the transfer thyristor T1. Accordingly, the electric potential of the gate terminal Gl1 of the light emitting thyristor L1 connected to the gate terminal Gm1 becomes “H” (0 V), and the threshold voltage of the light emitting thyristor L1 is −1.5 V.

However, because the light-up signal φI1 is “H,” no light emitting thyristor L is turned on.

Thus, the transfer thyristor T1 and the memory thyristor M1 are maintained in the ON state right after the time point c.

At this time, the electric potential of the cathode terminal of the memory thyristor M1 is −1.5 V obtained by subtracting the diffusion electric potential Vd (1.5 V) from “H” (0 V). However, the memory thyristor M is connected to the memory signal wire 74 via the resistance Rn. Therefore, the electric potential of the memory signal wire 74 is maintained at “L” (−3.3 V). The resistance Rn is set at a value with which the electric potential of the memory signal wire 74 is maintained at “L” even with the memory thyristor M being in the ON state.

In the above description, the operations of the thyristors (the transfer thyristors T, the memory thyristors M, and the light emitting thyristors L) and the diodes (the coupling diodes Dc and the connection diodes Dm) of the light emitting chip C1 have been described separately. Instead, the operations of the thyristors and the diodes may be described as follows.

When the thyristor is turned on, the electric potential of the gate terminal (each of the gate terminal Gt, the gate terminal Gm, and the gate terminal Gl) thereof becomes “H” (0 V). The electric potential of the gate terminal that is connected via one step (one piece) of a forward-biased diode to the gate terminal whose electric potential is “H” (0 V) is −1.5 V obtained by subtracting the diffusion electric potential Vd (1.5 V) from “H” (0 V). The threshold voltage of the thyristor including this gate terminal is −3 V. Further, the electric potential of the gate terminal connected via two steps (two pieces serially connected to each other) of a forward-biased diode to the gate terminal whose electric potential is “H” (0 V) is −3 V obtained by subtracting double diffusion electric potentials Vd (2×1.5 V) therefrom. The threshold voltage of the thyristor including the gate terminal is −4.5 V. Further, the gate terminal connected via three or more steps of the diodes with the gate terminal whose electric potential is “H” (0 V) is not influenced by the gate terminal being at “H” (0 V). The threshold voltage of the thyristor including the gate terminal that is connected via three or more steps of the diodes is maintained at −4.8 V.

The thyristor including the gate terminal that is connected via one step of the diode to the gate terminal whose electric potential is “H” (0 V) is turned on with the electric potential “L” (power supply electric potential: −3.3 V). The thyristor including the gate terminal that is connected via two or more steps of the diodes is not turned on with the electric potential “L” (−3.3 V).

In other words, the thyristor, including the gate terminal that is connected via one step of the diode to the gate terminal whose electric potential is “H” (0 V), is turned on and it is only necessary to focus this thyristor.

A description will be given of only the thyristor including the gate terminal that is connected via one step of the diode to the gate terminal whose electric potential is “H” (0 V), although a description of change in the electric potential or the threshold voltage of the gate terminal of the thyristor that is not turned on will be omitted.

It should be noted that the threshold voltage of the thyristor, connected to the gate terminal whose electric potential is “H” (0 V) without the interposing of the diode (coupling diode Dc, and connection diode Dm), is −1.5 V. In this case, the thyristor is turned on with the electric potential “L” (−3.3 V), and the electric potential higher than −3.3 V may be used.

Referring back to FIG. 8, the operation of the light emitting chip C1 will be further described. At the time point d, the memory signal φm1 changes from “L” to “S,” and the second transfer signal φ2 changes from “H” to “L.”

“S” is an electric potential with which the memory thyristor M being in the ON state maintains its ON state but the memory thyristor M being in the OFF state is not turned on.

As mentioned above, the threshold voltage for turning on the memory thyristor M is −3 V. The electric potential of the cathode terminal of the memory thyristor M being in the ON state is −1.5 V obtained by subtracting the diffusion electric potential Vd. Therefore, “S” is set at an electric potential that is higher than −3 V of the threshold voltage of the memory thyristor M to be turned on and lower than the electric potential (−1.5 V) of the cathode terminal being in the ON state. Note that “S” needs to be set at an electric potential for supplying an electric current with which the memory thyristor M being in the ON state maintains its ON state.

As described above, the memory thyristor M1 being in the ON state maintains its ON state even when the memory signal φm1 changes from “L” to “S.”

When the second transfer signal φ2 changes from “H” to “L,” the transfer thyristor T2, whose threshold voltage is −3 V, is turned on.

When the transfer thyristor T2 is turned on, the electric potential of the gate terminal Gt2 rises up to “H” (0 V). Then, the threshold voltage of the transfer thyristor T3, connected via one step of the forward-biased diode (coupling diode Dc2) to the gate terminal Gt2, is set at −3 V. Similarly, the threshold voltage of each of the memory thyristor M2 and the light emitting thyristor L2, connected via one step of the diode (connection diode Dm2) to the gate terminal Gt2, is set at −3 V.

In this case, the transfer thyristor T1 maintains its ON state. Therefore, the electric potential of the first transfer signal wire 72, to which the cathode terminal of the transfer thyristor T3 is connected, is maintained at the diffusion electric potential Vd (−1.5 V) due to the transfer thyristor T1 being in the ON state. Thus, the transfer thyristor T3 is not turned on.

In addition, because the memory signal φm1 is “S,” the memory thyristor M2 is not turned on. Similarly, because the light-up signal φI1 is “H,” the light emitting thyristor L2 is not turned on.

Note that at the time point d, the memory signal φm1 changes from “L” to “S,” and simultaneously the second transfer signal φ2 changes from “H” to “L.”

However, as the second transfer signal φ2 changes to “L,” the transfer thyristor T2 is turned on and, accordingly, the threshold voltage of the memory thyristor M2 is set at −3 V. If the memory signal φm1 is maintained at “H” at this moment, the memory thyristor M2 is turned on. Therefore, the memory signal φm will change from “L” to “S” before the second transfer signal φ2 changes from “H” to “L.”

Right after the time point d, both the transfer thyristors T1 and T2 are in the ON state, and the memory thyristor M1 is also in the ON state.

At the time point e, the first transfer signal φ1 changes from “L” to “H.” Then, the transfer thyristor T1 is turned off because both the cathode terminal and anode terminal thereof are set at “H.”

At this time, the gate terminal Gt1 of the transfer thyristor T1 is connected to the power supply wire 71 via the power supply wire resistance Rt1 and thus is set at −3.3 V of the power supply electric potential Vga. Because the coupling diode Dc1 between the gate terminals Gt1 (−3.3 V) and Gt2 (0 V) has a reverse bias, the gate terminal Gt1 is not influenced by the gate terminal Gt2 being at “H” (0 V).

Similarly, because the memory thyristor M1 is in the ON state, the gate terminal Gm1 is set at “H” (0 V). However, because the coupling diode Dm1 between the gate terminal Gt1 (−3.3 V) and the gate terminal Gm1 (0 V) has a reverse bias, the gate terminal Gt1 is not influenced by the gate terminal Gm1 being at “H” (0 V).

In other words, the electric potential of the gate terminal, connected via the reverse-biased diode to the gate terminal whose electric potential is at “H” (0 V), is not influenced by the latter gate terminal being at “H” (0 V). Note that the same applies to other diodes as for the relationship of the electric potential between the gate terminals connected via the reverse-biased diode, and therefore a description of the relationship of the other diodes is omitted.

Right after the time point e, the memory thyristor M1 and the transfer thyristor T2 maintain the ON state.

Next, at the time point f, the memory signal φm1 changes from “S” to “L” (−3.3 V), and then the memory thyristor M2, whose threshold voltage is −3 V, is turned on (referred to as “+M2 ON” in FIG. 8, and the others below will be illustrated similarly). The electric potential of the gate terminal Gm2 (G12) is “H” (0 V), and the threshold voltage of the light emitting thyristor L2 is −1.5 V. However, because the light-up signal φI1 is “H,” the light emitting thyristor L2 is not turned on.

Thus, right after the time point f, both the memory thyristors M1 and M2 are in the ON state. The transfer thyristor T2 maintains its ON state.

At the time point g, the memory signal φm1 changes from “L” to “S,” and the first transfer signal φ1 changes from “H” to “L”.

Even when the memory signal φm1 changes from “L” to “S”, the memory thyristors M1 and M2 in the ON state maintain its ON state.

On the other hand, when the first transfer signal φ1 changes from “H” to “L”, the transfer thyristor T3, whose threshold voltage is −3 V, is turned on. The electric potential of the gate terminal Gt3 is set at “H” (0 V), and the threshold voltage of the transfer thyristor T4, connected via one step of the forward-biased diode (coupling diode Dc3) to the gate terminal Gt3, is set at −3 V. Similarly, the threshold voltage of each of the memory thyristor M3 and the light emitting thyristor L3, connected via one step of the forward-biased diode (connection diode Dm3) to the gate terminal Gt3, is set at −3 V.

At this time, the transfer thyristor T2 maintains its ON state. Accordingly, the electric potential of the second transfer signal wire 73, to which the cathode terminal of the transfer thyristor T2 is connected, is maintained at −1.5 V with the transfer thyristor T2 in the ON state. Therefore, the transfer thyristor T4 is not turned on.

In addition, because the memory signal φm1 is “S,” the memory thyristor M3 is not turned on. Similarly, because the light-up signal φI1 is “H”, the light emitting thyristor L3 is not turned on.

Note that the memory signal φm1 changes from “L” to “S,” and simultaneously the first transfer signal φ1 changes from “H” to “L,” at the time point g. As mentioned above, the memory signal φm1 will change from “L” to “S” before the first transfer signal φ1 changes from “H” to “L.”

Right after the time point g, the memory thyristors M1 and M2 are maintained in the ON state. Both the transfer thyristors T2 and T3 are in the ON state.

Next, at the time point h, the second transfer signal φ2 changes from “L” to “H.” Then, similarly to the time point e, the transfer thyristor t2 is turned off. The gate terminal Gt2 of the transfer thyristor T2 is set at −3.3 V of Vga via the power supply wire resistance Rt2.

Thus, right after the time point h, the memory thyristors M1 and M2, and the transfer thyristor T3 are maintained in the ON state.

At the time point i, the memory signal φm1 changes from “S” to “L” (−3.3 V). Similarly to the time point f, the memory thyristor M3, whose threshold voltage is −3 V, is turned on. Then, the electric potential of the gate terminal Gm3 (G13) is set at “H” (0 V), and the threshold voltage of the light emitting thyristor L3 is set at −1.5 V. However, because the light-up signal φI1 is “H,” the light emitting thyristor L3 is not turned on.

Thus, right after the time point i, the memory thyristors M1, M2 and M3 are in the ON state. The transfer thyristor T3 is also maintained in the ON state.

At the time point j, the memory signal φm1 changes from “L” to “S,” and the second transfer signal φ2 changes from “H” to “L.”

Similarly to the time point g, even when the memory signal φm1 changes from “L” to “S,” the memory thyristors M1, M2 and M3 in the ON state maintain their ON state.

On the other hand, when the second transfer signal φ2 changes from “H” to “L,” the transfer thyristor T4, whose threshold voltage is −3 V, is turned on. Then, the electric potential of the gate terminal Gt4 is set at “H” (0 V), and the threshold voltage of the transfer thyristor T5, connected via one step of the forward-biased diode (coupling diode Dc4) to the gate terminal Gt4, is set at −3 V. Similarly, the threshold voltage of each of the memory thyristor M4 and the light emitting thyristor L4, connected via one step of the forward-biased diode (connection diode Dm4) to the gate terminal Gt4, is set at −3 V.

At this moment, the transfer thyristor T3 maintains its ON state. Because the electric potential of the first transfer signal wire 72, to which the cathode terminal of the transfer thyristor T5 is connected, is maintained at −1.5 V with the transfer thyristor T3 in the ON state, the transfer thyristor T5 is not turned on.

In addition, because the memory signal φm1 is “S,” the memory thyristor M4 is not turned on. Similarly, because the light-up signal φI1 is “H,” the light emitting thyristor L4 is not turned on.

Note that the memory signal φm1 changes from “L” to “S,” and the second transfer signal φ2 changes from “H” to “L” simultaneously at the time point j. As mentioned above, the memory signal φm1 will change from “L” to “S” before the second transfer signal φ2 changes from “H” to “L.”

Thus, right after the time point j, the memory thyristors M1, M2 and M3 are maintained in the ON state. The transfer thyristors T3 and T4 are in the ON state.

At the time point k, the first transfer signal φ1 changes from “L” to “H.” Then, similarly to the time point h, the transfer thyristor T3 is turned off. The gate terminal Gt3 of the transfer thyristor T3 is set at −3.3 V of the power supply electric potential Vga via the power supply wire resistance Rt3.

Thus, right after the time point k, the memory thyristors M1, M2, and M3, and the transfer thyristor T4 are maintained in the ON state.

At the time point 1, the memory signal φm1 changes from “S” to “L.” Then, similarly to the time point i, the memory thyristor M4, whose threshold voltage is −3 V, is turned on. The electric potential of the gate terminal Gm4 (G14) is set at “H” (0 V), and accordingly the threshold voltage of the light emitting thyristor L4 is set at −1.5 V. However, because the light-up signal φI1 is “H,” the light emitting thyristor L4 is not turned on.

Right after the time point 1, the memory thyristors M1, M2, M3 and M4 are in the ON state, and the transfer thyristor T4 is maintained in the ON state.

The gate terminals Gm1 (G11), Gm2 (G12), Gm3 (G13) and Gm4 (G14) of the memory thyristors M1, M2, M3 and M4 in the ON state are set at “H” (0 V). Accordingly, the threshold voltage of each of the light emitting thyristors L1, L2, L3 and L4 is set at −1.5 V. Note that the gate terminal Gl5 of the light emitting thyristor L5 located adjacent to the light emitting thyristor L4 is connected via two steps of the forward-biased diodes (coupling diode Dc4 and connection diode Dm5) to the gate terminal Gt4 being at “H” (0 V), whereby the threshold voltage thereof is −4.5 V. Further, the threshold voltage of the light emitting thyristor L, having 6 or a larger number, is set at −4.8 V.

At the time point m, the electric potential of the light-up signal φI1 is set at “Le,” which is lower than the above-mentioned threshold voltage (−1.5 V) of each of the light emitting thyristors L1, L2, L3 and L4 and higher than the threshold voltage (−3 V) of the light emitting thyristor L5 at the time point n described later.

Because the threshold voltage (−1.5 V) of each of the light emitting thyristors L1, L2, L3 and L4 is higher than “Le,” the light emitting thyristors L1, L2, L3 and L4 are turned on and light up (emit light).

In contrast, the light emitting thyristor L5 and the light emitting thyristors L each having 6 or a larger number are not turned on because the threshold voltage thereof is lower than “Le.”

In other words, in the present exemplary embodiment, multiple (four in this case) thyristors are caused to light up simultaneously.

Right after the time point m, the light emitting thyristors L1, L2, L3 and L4, and the memory thyristors M1, M2, M3 and M4, and the transfer thyristors T4 are in the ON state.

At the time point n, the memory signal φm1 changes from “L” to “H,” and the first transfer signal φ1 changes from “H” to “L.”

As the memory signal φm1 changes from “L” to “H,” the electric potential of the cathode terminals of the memory thyristors M1, M2, M3 and M4 is set at the same electric potential as “H” (0 V) of the anode terminal. Thus, the memory thyristors M1, M2, M3 and M4 are turned off.

On the other hand, when the first transfer signal φ1 changes from “H” to “L,” the transfer thyristor T5, whose threshold voltage is −3 V, is turned on. The electric potential of the gate terminal Gt5 is set at “H” (0 V), and the threshold voltage of the transfer thyristor T6, connected via one step of the forward-biased diode (coupling diode Dc5) to the gate terminal Gt5, is set at −3 V. Similarly, the threshold voltage of each of the memory thyristor M5 and the light emitting thyristor L5, connected via one step of the forward-biased diode (connection diode Dm5) to the gate terminal Gt5, is set at −3 V.

At this moment, the transfer thyristor T4 maintains its ON state. The electric potential of the second transfer signal wire 73, to which the cathode terminal of the transfer thyristor T6 is connected, is maintained at −1.5 V with the transfer thyristor T4 in the ON state, and therefore the transfer thyristor T6 is not turned on.

In addition, because the memory signal φm1 is “H,” the memory thyristor M5 is not turned on. On the other hand, because the light-up signal φI1 is at the light-up level “Le,” which is an electric potential higher than −3 V and lower than −1.5 V, the light emitting thyristor L5 is not turned on and remains off.

At the time point n, the memory signal φm1 changes from “L” to “H,” and the first transfer signal φ1 changes from “H” to “L” simultaneously. However, when the first transfer signal φ1 is set at “L,” the transfer thyristor T5 is turned on. In order to prevent the memory thyristor M5 from being turned on with the memory signal φm1 being at “L,” the memory signal φm1 will change from “L” to “H” before the first transfer signal φ1 changes from “H” to “L.”

Right after the time point n, the light emitting thyristors L1, L2, L3 and L4 are maintained in the light-up (ON) state. The transfer thyristors T4 and T5 are also in the ON state.

At the time point o, the second transfer signal φ2 changes from “L” to “H.” Accordingly, the transfer thyristor T4 is turned off. The gate terminal Gt4 of the transfer thyristor T4 is set at −3.3 V of the power supply electric potential Vga via the power supply wire resistance Rt4.

Thus, right after the time point o, the light emitting thyristors L1, L2, L3 and L4 are maintained in the light-up (ON) state. The transfer thyristor T5 maintains its ON state.

At the time point p, the light-up signal φI1 changes from “Le” to “H.” Then the electric potential of the cathode terminals of the light emitting thyristors L1, L2, L3 and L4 is set at “H” (0 V) that is the same as that of the anode terminals thereof. Thus, the light emitting thyristors L1, L2, L3 and L4 do not maintain their light-up (ON) state and are put out (turned off).

In other words, the light-up period Ton (#A) of the light emitting thyristors L1, L2, L3 and L4 is from the time point m to the time point p. Because the light emitting thyristors L1, L2, L3 and L4 simultaneously light up, all of the light-up period Ton (#A) of the light emitting thyristors L1, L2, L3 and L4 are the same.

As mentioned above, the length of the light-up period Ton (#A) (light-up period Ton) is set for suppressing the unevenness in the light exposure amounts of the light emitting thyristors L. Accordingly, the average light exposure amount of the group including the light emitting thyristors L1 to L4 belonging to the group #A is corrected for the reference light exposure amount. The same applies to the other light-up periods Ton, e.g., the light-up period Ton (#B).

Note that if the memory signal φm1 changes from “H” to “L” and the memory thyristor M5 is turned on within the period from the time point o to the time point p, the gate terminal Gm5 (equivalent to the gate terminal Gl5) is set at “H” (0 V), and the threshold voltage of the light emitting thyristor L5 rises up to −1.5 V. In this period, the light-up signal φI1 is “Le,” and therefore the light emitting thyristor L5 lights up.

In view of the above, in the present exemplary embodiment, the memory signal φm1 does not change to “L” until the time point p when the light emitting thyristors L1, L2, L3 and L4 are put out elapses.

Thus, right after the time point p, only the transfer thyristor T5 is maintained in the ON state.

At the time point q, the memory signal φm1 changes from “H” to “L.” When the memory signal φm1 changes from “S” to “L,” the memory thyristor M5, whose threshold voltage is −3 V, is turned on similarly to the time point c. The subsequent operations are repeated in the same manner as the operation after the time point c, and the light-up control on the light emitting thyristors L5 to L8 is performed in the period T (#B) in the same way as the period T (#A). The description on subsequent operations is omitted.

Note that in the description above, all the light emitting thyristors L1, L2, L3 and L4 of the light emitting chip C1 are caused to light up in the period T (#A). However, if the light emitting thyristor L is not caused to light up depending on the image data, it is only necessary to maintain the memory signal φm1 at “S.” More specifically, at a time period (timing) shown as M6 in the period T (#B) in FIG. 8, it is only necessary to maintain the memory signal φm1 at “S.” “S” is an electric potential that is higher than −3 V and lower than −1.5 V. Therefore, the memory thyristor M6, whose threshold voltage is −3 V, is not turned on. Thus, the memory thyristor M6 is not set in the ON state and remains off. Accordingly, even when the light-up signal φI1 is set at “Le,” the light emitting thyristor L6, whose gate terminal Gl6 is connected to the gate terminal Gm6 of the memory thyristor M6, does not light up (does not emit light) since the threshold voltage thereof is maintained at −4.8 V. In contrast, when the light-up signal φI1 (φI) is set at “Le,” the memory thyristors M5, M7 and M8 light up (emit light) since the threshold voltages thereof are −1.5 V.

As mentioned above, the light emitting chips C1 to C4 of the light emitting chip group CG1 are linked in a row via the SOU terminals and the SIN terminals. These light emitting chips function as a light emitting chip having four times the number of the light emitting thyristors L included in the single light emitting chip C. Accordingly, the operations of the light emitting chips C2 to C4 follow the operation of the light emitting chip C1 mentioned above.

On the other hand, the light emitting chips C belonging to the different light emitting chip groups CG are operated in parallel since the same first transfer signal φ1 and second transfer signal φ2 are fed thereto in the same way as the light emitting chips C of the light emitting chip group CG1.

In other words, in the period T (#A) of the light-up control, light-up control is performed, in response to the memory signal φm2 and the light-up signal φI2, on the light emitting thyristors L1 to L4 of the light emitting chip C8 belonging to the light emitting chip group CG2, in parallel with the light emitting thyristors L1 to L4 of the light emitting chip C1 belonging to the light emitting chip group CG1. The same applies to the other period T and other light emitting chip groups CG3 to CG10.

Alternatively, the description above may be described as follows.

In other words, in the present exemplary embodiment, in response to the first transfer signal φ1 and the second transfer signal φ2, the transfer thyristor T changes from the OFF state to the ON state or from the ON state to the OFF state in the numerical order, and there is a period in which the adjacent two transfer thyristors T are both in the ON state (for example, the period between the time point d and the time point e in FIG. 8). That is, the ON state shifts through the transfer thyristors T in the numerical order of the transfer thyristor array.

When either the first transfer signal φ1 or the second transfer signal φ2 is “L,” only a single transfer thyristor T is in the ON state. For example, only the transfer thyristor T1 is in the ON state in the period between the time point c and the time point d.

When the transfer thyristor T is in the ON state, the threshold voltage of the memory thyristor M having the gate terminal Gm connected to the gate terminal Gt thereof rises.

At timing when only a single transfer thyristor T is in the ON state (for example, the time points c, f, i, and 1 in FIG. 8), the memory thyristor M, whose threshold voltage has risen due to the transfer thyristor T in the ON state, is turned on by changing the memory signal φm to “L.”

The memory signal φm is changed between “S” and “L” without returning to “H.” In this way, for the predetermined number of light emitting thyristors L, the memory thyristors M having the same number as the light emitting thyristors L intended to light up are set in the ON state, whereas the memory thyristors M having the same number as the light emitting thyristors L not intended to light up are maintained in the OFF state.

In other words, in order to cause multiple light emitting thyristors L to light up simultaneously, the positions (numbers) of the light emitting thyristors L to be caused to light up are memorized by changing the memory thyristors M, having the same (corresponding) number, to the ON state.

Then, the multiple light emitting thyristors L intended to light up are caused to light up by feeding the light-up signal φI thereto. This is because the electric potential of the gate terminal Gm of the memory thyristor M in the ON state is the same as the electric potential (“H” (0 V)) of the anode terminal, and the threshold voltage of the light emitting thyristor L having the same number rises accordingly. Thereby the light emitting thyristor L having the same number as the memory thyristor M in the ON state may be caused to light up (to emit light) by feeding the light-up signal φI1 thereto.

The transfer thyristors T have a shift function and thereby specify the positions of the light emitting thyristors L in turn. On the other hand, the memory signal φm is set at “L” or “S” depending on the image data and thereby sets information on whether the specified light emitting thyristor L is caused to light up or not. The memory thyristors M have a function (latch function) with which the positions (numbers) of the light emitting thyristors L to be caused to light up are memorized by maintaining the ON state of multiple thyristors M having the same numbers as the light emitting thyristors L to be caused to light up simultaneously.

Note that when the light emitting thyristors L light up, the memory signal φm is set at “H,” all the memory thyristors M are turned off, and the memory of the positions (numbers) of the light emitting thyristors L intended to light up is deleted.

In other words, “L” of the memory signal φm is an instruction for causing the light emitting thyristor L to light up, “S” of the memory signal φm is an instruction for not causing the light emitting thyristor L to light up, and “H” of the memory signal φm is an instruction for clearing (resetting) the memorized instruction.

In the present exemplary embodiment, the cathode terminal of the memory thyristor M is connected via the resistance Rn to the memory signal wire 74 to which the memory signal φm is fed. Accordingly, even when the memory thyristor M is set in the ON state, the memory signal wire 74 is not drawn into the electric potential of the cathode terminal of the memory thyristor M. Thus, while a certain memory thyristor M is in the ON state, other memory thyristors M may be turned on when the threshold voltage of the other memory thyristors M is higher than “L.”

As described above, the multiple memory thyristors M, having the same numbers as the multiple light emitting thyristors L intended to light up simultaneously, are set in the ON state, and then the multiple memory thyristors M maintain and memorize their ON state. In this state, the multiple light emitting thyristors L are caused to light up simultaneously by feeding the light-up signal φI thereto.

It should be noted that the electric current for maintaining the ON state of the memory thyristor M may be lower than the electric current for causing the light emitting thyristors L to light up. In this way, the resistance Rn occupies a small area on the board 80 of the light emitting chip C, whereby an increase in the area of the light emitting chip C may be suppressed.

Because the multiple light emitting points (light emitting thyristors L) are caused to light up simultaneously in a single light-up period Ton (for example, from the time point m to the time point p), the light-up period Ton may be shortened compared with a case where the light emitting thyristors L are caused to light up one by one. Thus, even when the light emitting chips C are driven as a group, there is no influence on the amount of time for exposing the photoconductive drum 12 by use of the print head 14. In this way, the number of the light-up signal wires (including light-up control signal wires) may be set lower than the number of the light emitting chips C.

FIG. 9 is a timing chart for explaining another operation of the light emitting chip C1. FIG. 9 shows a case in FIG. 6B where light-up control is performed on each group including the eight light emitting thyristors L. FIG. 9 shows a part where light-up control is performed on the eight light emitting thyristors L of the group #A, and all the eight light emitting thyristors L1 to L8 of the group #A are caused to light up in the period T (#A).

Note that the light-up period signal Per and the light-up control signal φJ in FIG. 9 will be described later.

In FIG. 9, similarly to FIG. 8, passing of time is illustrated in alphabetical order from the time point a to the time point q except for a part (the time point m) described below, and the same time points as FIG. 8 are used. Light-up control is performed on the light emitting thyristors L1 to L8 of the group #A in FIG. 6B, in the period T (#A) between time points c and q.

The period T (#A) in FIG. 9 repeats two times the period between the time point c and the time point n illustrated in FIG. 8 in which four memory thyristors M are set in the ON state. Accordingly, the time point m when the light-up signal φI1 (φI) is set at “Le” is shifted and located between the time point o and the time point p.

The operation of the light emitting chip C1 is the same as that in the case described above where there are four light emitting points (light emitting thyristors L), and therefore the description on the operation is omitted.

It should be noted that as shown in FIGS. 8 and 9, eight light emitting points (light emitting thyristors L) may be caused to light up simultaneously only by changing timings of the first transfer signal φ1, the second transfer signal φ2, the memory signal φm1, and the light-up signal φI1 without changing the light emitting chip C1.

Thus, the number of the light emitting points (light emitting thyristors L) to be caused to light up simultaneously may be arbitrarily set.

Note that each of the light-up signals φI (φI1 to φI10) in the circuit shown in FIG. 4 is fed by the driving by the electric current, as mentioned above.

When each of the light-up signals φI (φI1 to φI10) is fed by the driving by a constant voltage, an electric current I that flows through the light emitting chip C is calculated by the equation “I=(V−Vd)/R” with the electric potential V of the power supply, diffusion electric potential Vd, and external resistance R. Accordingly, each electric current flowing through the multiple light emitting thyristors L being lighting up (emitting light) simultaneously is obtained by dividing the electric current I by the number of the light emitting thyristors L being lighting up (emitting light) simultaneously. In other words, the electric current flowing through each of the light emitting thyristors L changes depending on the number of light emitting thyristors L intended to light up (emit light) simultaneously, thereby fluctuating the light exposure amount. To avoid this, the amount of supplied electric current may be changed depending on the number of the light emitting thyristors L to be caused to light up, in order to suppress the fluctuation in each light exposure amount regardless of the number of the light emitting thyristors L to be caused to light up (emit light) simultaneously.

In addition, the number of the light emitting thyristors L to be caused to light up simultaneously is determined on the basis of the image data inputted to the light emitting chip C. Therefore, it is easy to set the electric current value corresponding to the number of the light emitting thyristors L to be caused to light up simultaneously.

In the case of the driving by the electric current, the electric current supplied to the light emitting thyristors L for each group is constant regardless of wire resistance. Even when the light exposure amount differs to some extent among the light emitting thyristors L within the group, the difference in the light exposure amount among the light emitting thyristors L is hardly recognized if the pitch of the light emitting thyristors L is higher than a spatial frequency that is recognized by human eyes.

Note that the light-up signals φI (φI1 to φI10) may be driven by a voltage.

In the case of the driving by the voltage, wire resistance is different depending on the lengths of the light-up signal lines 109 (109_1 to 109_10) located on the circuit board 62. Therefore, the electric current for causing the light emitting thyristors L to light up (emit light) is different depending on the wire resistance, and the light exposure amount differs for each light emitting thyristor L. Even in this case, the light exposure amount may be corrected for each group by storing the value of the wire resistance in the LUT 102 and controlling the voltage supplied to the light emitting thyristors L belonging to each group.

Hereinafter, the signal generating circuit 100 will be described.

FIG. 10 is a block diagram showing a configuration of the signal generating circuit 100. The main part of the signal generating circuit 100 is formed of an image data loading unit 111, a density unevenness correction data unit 112, a timing signal generating unit 114, a reference clock generating unit 116, the light-up control signal generating units 110 (110_1 to 110_10), and the light-up signal feeding circuits 101 (101_1 to 101_10). Here, each of the light-up control signal generating units 110 (110_1 to 110_10) serves as an example of a driving unit provided to the corresponding one of the light emitting chip groups CG (CG1 to CG10).

Image data is serially transmitted from the image processing unit 40 to the image data loading unit 111. The image data loading unit 111 divides the transmitted image data corresponding to the light emitting chip groups CG (CG1 to CG10) into pieces of image data for the respective light emitting chip groups CG (CG1 to CG10): 1st to 512th dots, 513th to 1026th dots, . . . and up to 4609th to 5120th dots. The image data loading unit 111 is connected to the light-up control signal generating units 110 (110_1 to 110_10) and outputs the divided image data to the corresponding light-up control signal generating units 110 (110_1 to 110_10). The image data is also outputted to the timing signal generating unit 114.

The density unevenness correction data unit 112 temporarily stores therein the unevenness correction data for modifying unevenness in image density at image formation due to variation in the light amounts of the light emitting thyristors L (see FIG. 5) of the light emitting chips C (C1 to C40) or the like. The density unevenness correction data unit 112 outputs the unevenness correction data to the light-up control signal generating units 110 (110_1 to 110_10) as needed. For example, for each group including the light emitting thyristors L to light up simultaneously, the unevenness correction data is made as the number of pulses that is set according to the variation in the light amounts of the light emitting thyristors L.

For example, the unevenness correction data is stored in the LUT 102 formed of an EEPROM. For example, the unevenness correction data is loaded into the density unevenness correction data unit 112 at timing of the power ON sequence of the image forming apparatus 1 (see FIG. 1).

The reference clock generating unit 116 is connected to the image output controlling unit 30 of the image forming apparatus 1, the timing signal generating unit 114, and the light-up control signal generating units 110 (110_1 to 110_10).

The timing signal generating unit 114 is connected to the image output controlling unit 30 and the reference clock generating unit 116. On the basis of an oscillation signal from the reference clock generating unit 116, the timing signal generating unit 114 is synchronized with a horizontal synchronization signal (Hsync) from the image output controlling unit 30 and generates the first transfer signal φ1, the second transfer signal φ2, and the memory signals φm (φm1 to φm10). For example, the memory signals φm (φm1 to φm10) may be generated from a reset timing signal (rst_d) generated by the timing signal generating unit 114 and the image data.

In addition, the timing signal generating unit 114 is connected to the density unevenness correction data unit 112 and the image data loading unit 111. On the basis of the oscillation signal from the reference clock generating unit 116, the timing signal generating unit 114 is synchronized with the Hsync signal from the image output controlling unit 30, and the timing signal generating unit 114 outputs, to each unit, a data reading signal for reading image data corresponding to each image pixel from the image data loading unit 111 and a data reading signal for reading unevenness correction data corresponding to each group including the light emitting thyristors L to be caused to light up simultaneously from the density unevenness correction data unit 112. Further, the timing signal generating unit 114 is connected to the light-up control signal generating units 110_1 to 110_10. On the basis of the oscillation signal from the reference clock generating unit 116, the timing signal generating unit 114 is synchronized with the Hsync signal from the image output controlling unit 30 and outputs a trigger signal (TRG) for starting the light-up of the light emitting unit 63.

Although a detailed description will be given later, each of the light-up control signal generating units 110 (110_1 to 110_10) correct the light-up period of each light emitting thyristor L on the basis of the unevenness correction data and the light-up period correction data (light-up period correction information). Then, each of the light-up control signal generating units 110 (110_1 to 110_10) generates corresponding one of the light-up control signals φJ (φJ1 to φJ10), which is a control signal serving as a basis for each of the light-up signal φI (φI1 to φI1) for causing each light emitting thyristor L of the light emitting unit 63 to light up.

In addition, the light-up signal feeding circuits 101 (101_1 to 101_10) amplify the light-up control signals φJ (φJ1 to φJ10) outputted from the light-up control signal generating units 110 (110_1 to 110_10), and these amplified signals are regarded as the light-up signals φI (φI1 to φI10).

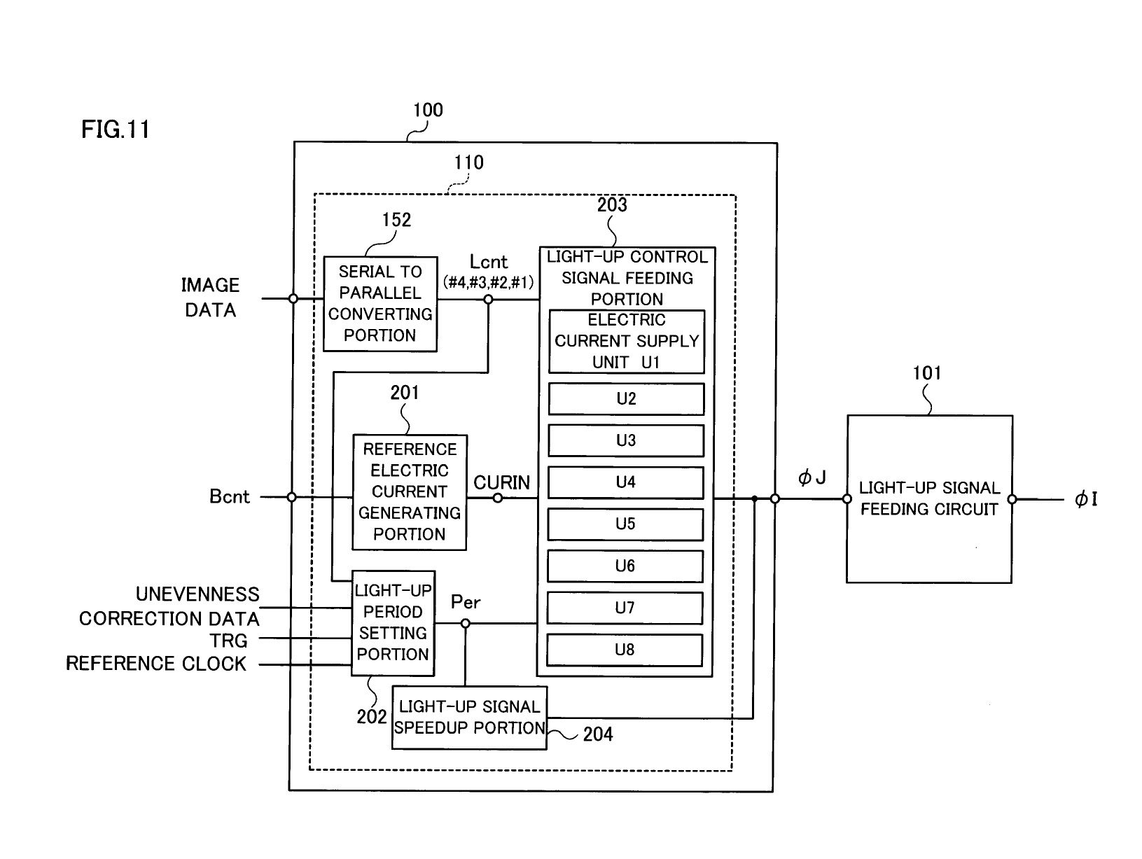

Hereinbelow, a detailed description will be given of the circuit for feeding the light-up signals φI (φI1 to φI10), that is, the light-up control signal generating unit 110 and the light-up signal feeding circuit 101 in FIG. 4. Here, a description will be given of a case where light-up control is performed on the eight light emitting points (light emitting thyristors L) shown in FIG. 6B as a single group. FIG. 11 is a diagram for explaining each of the light-up control signal generating units 110 (110_1 to 110_10) and each of the light-up signal feeding circuits 101 (101_1 to 101_10) included in the signal generating circuit 100.

### <Light-Up Control Signal Generating Unit 110>

The light-up control signal generating unit 110 includes a serial to parallel converting portion 152, a reference electric current generating portion 201, a light-up period setting portion 202, a light-up control signal feeding portion 203 as an example of an electric current supply portion, and a light-up signal speedup portion 204.

The serial to parallel converting portion 152 obtains the image data outputted from the image data loading unit 111 (see FIG. 10), and then converts the serial data of the image data into parallel data of a light-emitting-point number setting signal Lcnt (#4, #3, #2, #1), and outputs the parallel data.

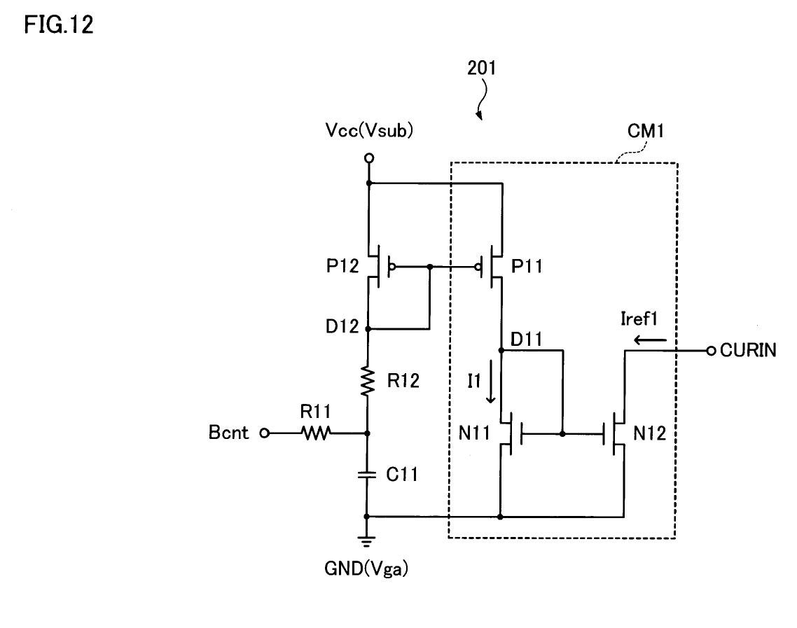

The reference electric current generating portion 201 generates an electric current that is used as a reference for each of the light-up signals φI (φI1 to φI10) (reference electric current Iref1 in FIG. 12 described later). The reference electric current generating portion 201 receives a light-exposure-amount setting signal Bcnt for setting the light exposure amount of the light emitting points (light emitting thyristors L) transmitted from the image output controlling unit 30. Then, on the basis of the light-exposure-amount setting signal Bcnt, the reference electric current Iref1 is supplied to the light-up control signal feeding portion 203 via a CURIN terminal.

The light-up period setting portion 202 receives the unevenness correction data from the LUT 102. As shown in FIG. 9, the light-up period setting portion 202 transmits, to the light-up control signal feeding portion 203, the light-up period signal Per that is set at “H” in the light-up period Ton and at “L” in the other period.

The light-up control signal feeding portion 203 includes, for example, eight electric current supply units U (U1 to U8). The reference electric current Iref1 supplied from the reference electric current generating portion 201 is divided equally into electric currents Iref2 (=Iref1/8), which are supplied to the eight electric current supply units U (U1 to U8).

As mentioned above, the light-up control signal feeding portion 203 receives the four-bit light-emitting-point number setting signal Lcnt (#4, #3, #2, #1) that sets the number of the light emitting points (light emitting thyristors L) to be caused to light up simultaneously (light-emitting-point number) (0 to 8 in the present exemplary embodiment). The electric current supply units U (U1 to U8) to be used are set according to the number of the light emitting points. As shown in FIG. 9, while the light-up period signal Per is “H,” the electric currents are supplied from the electric current units U being set for use. Then, the electric currents are superimposed with each other to form the light-up control signal φJ, which is fed to the light-up signal feeding circuit 101. In other words, each of the light-up control signals φJ (φJ1 to φJ10) is an electric current obtained by multiplying a unit of electric current several times (0 to 8 times), and is also an electric current using a unit of an electric current (unit electric current Iunit) supplied by a single electric current supply unit U. When the number of the light emitting points is 0 (zero), an electric current is not supplied from the electric current supply units U. The detailed description thereof will be given with the description of the light-up control signal feeding portion 203.

By this configuration, the electric current of each of the light-up signals φI (φI1 to φI10) may be changed depending on the number of the light emitting points (light emitting thyristors L) intended to light up simultaneously.

The light-up signal speedup portion 204 receives the light-up period signal Per from the light-up period setting portion 202 of the light-up control signal generating unit 110 and speeds up the operation of switching the light-up signal φI from the ON state to the OFF state. In other words, the light-up signal speedup portion 204 recognizes the timing when the light-up period signal Per changes from “H” to “L,” forcibly sets the electric potential of the light-up signal φI at “H,” and terminates the light-up period Ton.

As will be described later, the light exposure amount of the light emitting thyristor L may be changed (corrected) also by using either the reference electric current Iref1 generated by the reference electric current generating portion 201 or the light-up period signal Per generated by the light-up period setting portion 202.

Because the reference electric current Iref1 may be changed according to the electric potential of the light-exposure-amount setting signal Bcnt, the reference electric current Iref1 may be used for density control when the image density is dark as a whole or when the image density is light as a whole. The light-up period signal Per may be used for correcting the light exposure amount for each group.

The light-up signal feeding circuit 101 receives corresponding one of the light-up control signals φJ (φJ1 to φJ10) from the light-up control signal feeding portion 203 of the light-up control signal generating unit 110 and feeds corresponding one of the light-up signals φI (φI1 to φI10) for corresponding one of the light emitting chip groups CG.

Hereinbelow, a detailed description will be given of the reference electric current generating portion 201, the light-up control signal feeding portion 203, the light-up signal speedup portion 204, and the light-up signal feeding circuit 101. Note that the light-up signals φI1 to φI10 and the light-up control signals φJ1 to φJ10 are each not distinguished from each other, and are referred to as “light-up signals φI” and “light-up control signals φJ,” respectively.

### (Reference Electric Current Generating Unit)

FIG. 12 is a diagram for explaining the reference electric current generating portion 201. In the present exemplary embodiment, the reference electric current generating portion 201 is formed of CMOS circuits including p-channel MOS transistors (hereinafter, abbreviated as p-channel transistors) and n-channel MOS transistors (hereinafter, abbreviated as n-channel transistors).

In the present exemplary embodiment, a transistor with P (for example, P11) is a p-channel transistor while a transistor with N (for example, N11) is an n-channel transistor.

The reference electric current generating portion 201 includes a capacitor C11, resistances R11 and R12, p-channel transistors P11 and P12, and n-channel transistors N11 and N12. The p-channel transistor P11 and the n-channel transistors N11 and N12 constitute a current mirror circuit CM1. The light-exposure-amount setting signal Bcnt is fed to the Bcnt terminal.

A description will be given of the electric connection among the devices. The Bcnt terminal, to which the light-exposure-amount setting signal Bcnt is fed, controls the electric current supply and is connected to one terminal of the capacitor C11 via the resistance R11. The other terminal of the capacitor C11 is connected to the GND terminal. The one terminal of the capacitor C11 is connected (at the connection point D12) via the resistance R12 to the drain terminal of the p-channel transistor P12. The source terminal of the p-channel transistor P12 is connected to the Vcc terminal.

The source terminal of the p-channel transistor P11 is connected to the Vcc terminal, and the source terminal of the n-channel transistor N11 is connected to the GND terminal. The drain terminal of the p-channel transistor P11 and the drain terminal of the n-channel transistor N11 are connected to each other (at the connection point D11).

The gate terminals of the p-channel transistor P11 and the p-channel transistor P12 are connected to each other and connected to the drain terminal of the p-channel transistor P12 (at the connection point D12). The gate terminal of the n-channel transistor N11 is connected to the drain terminal of the p-channel transistor P11 (also the drain terminal of the n-channel transistor N11) (at the connection point D11).

The source terminal of the n-channel transistor N12 is connected to the GND terminal, and the drain terminal thereof is connected to the CURIN terminal that supplies the reference electric current Iref1. The gate terminal of the n-channel transistor N12 is connected to the drain terminal of the n-channel transistor N11 (at the connection point D11).

It should be noted that the Vcc terminal is connected to the Vsub terminal (0 V) to which the reference electric potential Vsub in FIG. 4 is supplied, and the GND terminal is connected to the Vga terminal (−3.3 V) to which the power supply electric potential Vga in FIG. 4 is supplied. The Vcc terminal is “H” while the GND terminal is “L.” Note that in the description of a logic circuit, “H” indicates “1” and “L” indicates “0.”

Next, a description will be given of the operation of the reference electric current generating portion 201.

The light-exposure-amount setting signal Bcnt is a reference electric potential that is set between the reference electric potential Vsub and the power supply electric potential Vga. With the light-exposure-amount setting signal Bcnt, the p-channel transistor P11 and the p-channel transistor P12 are set in the conductive state (the ON state). The electric current flowing through the p-channel transistor P11 is dependent on the electric potential of the gate terminal (the connection point D12) of the p-channel transistor P11. As the electric potential gets closer to the power supply electric potential Vga, more electric current flows through the p-channel transistor P11. In contrast, as the electric potential applied to the gate terminal of the p-channel transistor P11 gets closer to the reference electric potential Vsub, less electric current flows through the p-channel transistor P11.

When the p-channel transistor P11 is in the ON state, the electric potential of the drain terminal (connection point D11) of the p-channel transistor P11 gets closer to the reference electric potential Vsub. Because the gate terminal of the n-channel transistor N11 is connected to the drain terminal of the p-channel transistor P11, the n-channel transistor N11 is set in the conduction state (ON state).

As described above, both the p-channel transistor P11 and the n-channel transistor N11 are set in the conduction state (ON state). The electric current I1 flowing through the p-channel transistor P11 and the n-channel transistor N11 is determined by the conduction states of the p-channel transistor P11 and the n-channel transistor N11.

The gate terminal of the n-channel transistor N12 is connected to the gate terminal of the n-channel transistor N11. Due to the current mirror effect, the reference electric current Iref1 flowing through the n-channel transistor N 12 is determined by the electric current I1 flowing through the n-channel transistor N11. In other words, if the n-channel transistor N11 has the same size (same channel width W and channel length L) as the n-channel transistor N12, mutual conductances are the same, whereby the electric current I1 and the reference electric current Iref1 are the same. In contrast, if the mutual conductances of the n-channel transistor N12 and the n-channel transistor N11 are different, the reference electric current Iref1 is determined by the ratio between the mutual conductances with respect to the electric current I1.

The electric current I is determined by the electric potential of the light-exposure-amount setting signal Bcnt. In other words, when the electric potential of the light-exposure-amount setting signal Bcnt is decreased, the electric current I1 is increased. On the contrary, when the electric potential of the light-exposure-amount setting signal Bcnt is increased, the electric current I1 is decreased. The reference electric current Iref1 may be adjusted by changing the electric potential (reference electric potential) of the light-exposure-amount setting signal Bcnt.

Note that as illustrated by the flow direction of the electric current, the reference electric current Iref1 is drawn from the CURIN terminal.

Although a simple electric current setting method has been described above, the configuration is not limited to the present exemplary embodiment as long as the accurate electric current is supplied as the light-up signal φI.

### (Light-Up Control Signal Feeding Portion)

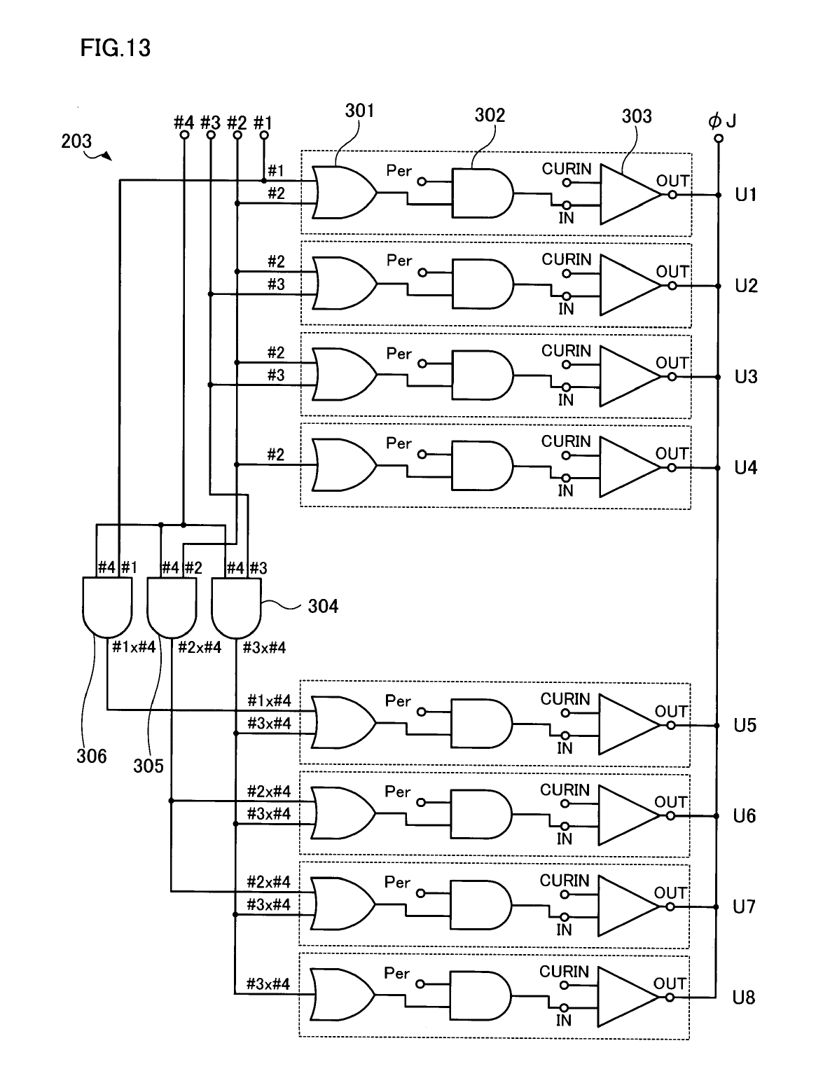

FIG. 13 is a logic circuit diagram for explaining the light-up control signal feeding portion 203.

The light-up control signal feeding portion 203 includes the eight electric current supply units U (U1 to U8), and three AND circuits 304, 305 and 306. Each electric current supply unit U includes an OR circuit 301, an AND circuit 302, and an electric current supplying circuit 303.

To the AND circuits 304, 305 and 306 as well as the OR circuits 301 of the electric current supply units U1 to U4, corresponding wires (#4, #3, #2, #1) through which the four-bit light-emitting-point number setting signal Lcnt is transmitted are connected in predetermined combinations.

To the OR circuits 301 of the electric current supply units U5 to U8, corresponding wires (#3×#4, #2×#4, #1×#4) through which results calculated by the AND circuits 304, 305 and 306 are transmitted are connected in predetermined combinations.

The output of the OR circuit 301 of each electric current supply unit U is connected to one of the two input terminals of the AND circuit 302. The light-up period signal Per is inputted to the other input terminal of the AND circuit 302.

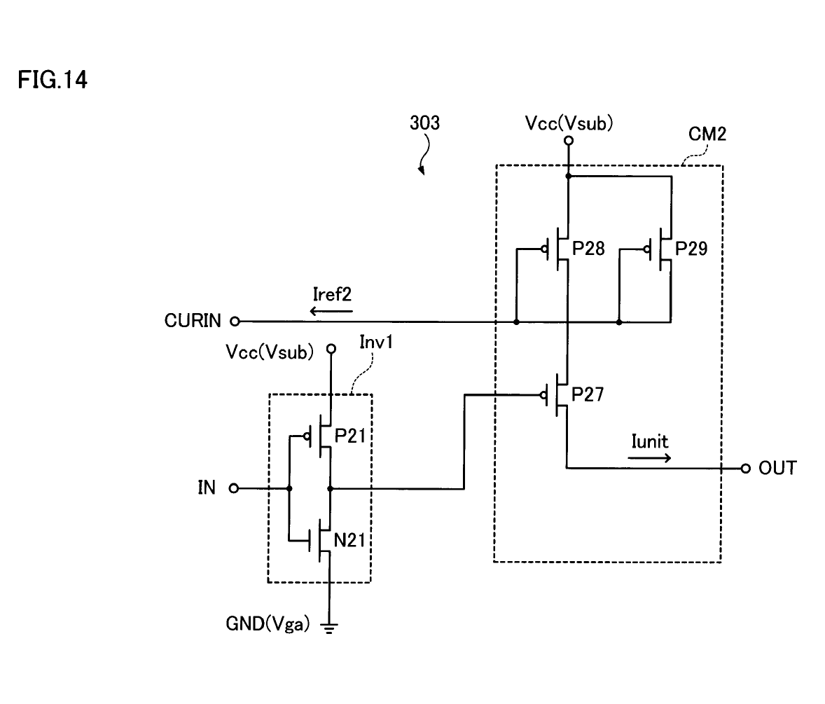

The output of the AND circuit 302 is transmitted to the IN terminal of the electric current supplying circuit 303. Further, the electric current Iref2 (see FIG. 14 described later) is supplied to the CURIN terminal of the electric current supplying circuit 303. Note that as shown in FIG. 11, the reference electric current Iref1 is divided and supplied equally to the eight electric current supplying circuits 303. Thus, the electric current Iref2 is equal to the reference electric current Iref1/8.

In addition, the light-up period signal Per is supplied in parallel to each electric current supplying circuit 303.

The wires from the OUT terminals of the electric current supplying circuits 303 are concentrated into a single wire and connected to the φJ terminal.

Next, a description will be given of a feature in which the light-up control signal feeding portion 203 sets, on the basis of the four-bit light-emitting-point number setting signal Lcnt, the electric current according to the number of the light emitting points (light emitting thyristors L) intended to light up (emit light) simultaneously.

For the number of the light emitting points, Table 1 illustrates examples of bit patterns of four bits (combinations of bit #1 to bit #4) set by the light-emitting-point number setting signal Lcnt. Each combination of the bits (#1, #2, #3, #4) determines ON or OFF of the electric current supply units U (U1 to U8).

TABLE 1

| NUMBER | | | | | ELECTRIC CURRENT | | | | | | | |
|---|---|---|---|---|---|---|---|---|---|---|---|---|
| OF LIGHT | BIT | | | | SUPPLY UNITS | | | | | | | |
| EMITTING | PATTERN | | | | (1: ON, 0: OFF) | | | | | | | |
| POINTS | #4 | #3 | #2 | #1 | U1 | U2 | U3 | U4 | U5 | U6 | U7 | U8 |
| 0 | 0 | 0 | 0 | 0 | 0 | 0 | 0 | 0 | 0 | 0 | 0 | 0 |
| 1 | 0 | 0 | 0 | 1 | 1 | 0 | 0 | 0 | 0 | 0 | 0 | 0 |
| 2 | 0 | 1 | 0 | 0 | 0 | 1 | 1 | 0 | 0 | 0 | 0 | 0 |
| 3 | 0 | 1 | 0 | 1 | 1 | 1 | 1 | 0 | 0 | 0 | 0 | 0 |
| 4 | 0 | 0 | 1 | 0 | 1 | 1 | 1 | 1 | 0 | 0 | 0 | 0 |
| 5 | 1 | 0 | 1 | 1 | 1 | 1 | 1 | 1 | 1 | 0 | 0 | 0 |
| 6 | 1 | 0 | 1 | 0 | 1 | 1 | 1 | 1 | 1 | 1 | 1 | 0 |
| 7 | 1 | 0 | 1 | 1 | 1 | 1 | 1 | 1 | 0 | 1 | 1 | 0 |
| 8 | 1 | 1 | 1 | 0 | 1 | 1 | 1 | 1 | 1 | 1 | 1 | 1 |

Hereinbelow, in the logic circuit, “H” is denoted by “1,” and “L” is denoted by “0.”

For example, when the number of the light emitting points is “1,” only the bit #1 is set at “1,” and the other bits #2, #3 and #4 are set at “0.” Then, for the OR circuit 301 of each of the electric current supply units U (U1 to U8), only the input terminal receiving bit #1 is “1.” In other words, only the input terminal indicated by #1 is “1” in the OR circuit 301 of the electric current unit U1.

Accordingly, the output of the OR circuit 301 of the electric current supply unit U1 is “1,” and the output of the AND circuit 302 is “1” while the light-up period signal Per is “1.” Although the electric current supplying circuit 303 will be described later in detail, the electric current is supplied to the φJ terminal from the OUT terminal of the electric current supplying circuit 303 of the electric current supply unit U1. However, in the other electric current units U2 to U8, all input terminals of the OR circuits 301 are “0,” and accordingly the outputs of the OR circuits 301 remain at “0.” The outputs of the AND circuits 302 thereof are also maintained at “0.” Thus, the electric current is not supplied to the φJ terminal from the OUT terminals of the other electric current supplying circuits 303.

Therefore, in the case where the number of the light emitting points is 1, the unit electric current Iunit corresponding to a single electric current supply unit U is supplied to the φJ terminal from only the electric current supply unit U1.

Similarly, when the number of the light emitting points is 2, the bit #3 is set at “1” and the other bits #1, #2 and #4 are set at “0.” Then, only the input terminals with #3 of the OR circuits 301 are set at “1” in the electric current supply units U2 and U3. Accordingly, the unit electric currents Iunit are supplied from the OUT terminals of the electric current supply units U2 and U3, respectively, and superimposed with each other to supply the double unit electric current Iunit (2×Iunit) to the φJ terminal. In other words, the electric current proportional to the number of the light emitting points, that is, 2 light emitting points, is supplied to the φJ terminal.

When the number of the light emitting points is 6, the bits #2 and #4 are set at “1,” and the other bits #1 and #3 are set at “0.” In addition, the output terminal of the AND circuit 305 is set at “1.” Then, only the input terminals with #2 and #2×#4 of the OR circuits 301 are set at “1.” Thus, the unit electric currents Iunit are supplied from the OUT terminals of the electric current supply units U1, U2, U3, U4, U6 and U7, respectively, and superimposed with each other to supply six times of the unit electric current Iunit (6×Iunit) to the φJ terminal. In other words, the electric current proportional to the number of the light emitting points, that is, 6 light emitting points, is supplied to the φJ terminal.

The same applies to cases with different numbers of the light emitting points. Note that the bit patterns of the light-emitting-point setting signal Lcnt are not limited to those shown in the Table 1 and may include other kinds of combinations. Further, the logic circuit shown in FIG. 13 may have a different configuration as long as the electric current proportional to the number of the light emitting points is supplied to the φJ terminal.

In FIG. 13, the eight electric current units U having the same configuration are arranged, and each of these electric current supply units U supplies the same unit electric current Iunit. However, the electric current values supplied from the respective electric current supply units U may be different from each other. For example, the electric current supplied from each electric current supply unit U may be set with weight 1, 2, 4 or 8. In this case, the bit pattern of the light-emitting-point number setting signal Lcnt may be set in such a manner that zero to eight times of the unit electric current Iunit is supplied.

### (Electric Current Supplying Circuit in the Electric Current Supply Unit)

Next, a description will be given of the electric current supplying circuit 303 in each electric current supply unit U.

FIG. 14 is a circuit diagram for explaining the electric current supplying circuit 303. In the present exemplary embodiment, the electric current supplying circuit 303 is formed of CMOS circuits.

The electric current supplying circuit 303 includes an inverter circuit Inv1 whose input terminal is connected to an IN terminal; and a current mirror circuit CM2.

The inverter circuit Inv1 includes a p-channel transistor P21 and an n-channel transistor N21.

The current mirror circuit CM2 includes p-channel transistors P27 and P28 that are serially connected to each other, and a p-channel transistor P29.

The gate terminals of the p-channel transistor P21 and the n-channel transistor N21 are connected to each other, and thereby constituting the input terminal of the inverter circuit Inv1. The drain terminals of the p-channel transistor P21 and the n-channel transistor N21 are connected to each other, and thereby constituting the output terminal of the inverter circuit Inv1. The source terminal of the p-channel transistor P21 is connected to the Vcc terminal, and the source terminal of the n-channel transistor N21 is connected to the GND terminal.

The input terminal of the inverter circuit Inv1 is connected to the IN terminal, and the output terminal thereof is connected to the gate terminal of the p-channel transistor P27.

The source terminal of the p-channel transistor P27 is connected to the OUT terminal. The drain terminal of the p-channel transistor P27 is connected to the source terminal of the p-channel transistor P28. The source terminal of the p-channel transistor P28 is connected to the Vcc (Vsub) terminal. The source terminal of the p-channel transistor P29 is also connected to the Vcc terminal. The gate terminals of the p-channel transistors P28 and P29 are both connected to the CURIN terminal.

When the reference electric current Iref1 is drawn from the CURIN terminal of the reference electric current generating portion 201 shown in FIG. 12, the electric current Iref2, which is ⅛ of the reference electric current Iref1, is supplied to the p-channel transistor P29.

In this case, if the IN signal is “1” (“H”), the output terminal of the inverter circuit Inv1 is “L.” Then, the p-channel transistor P27 is turned ON, and then corresponding to the electric current Iref2, the current mirror causes the unit electric current Iunit to flow out of the OUT terminal via the p-channel transistor P28 and the p-channel transistor P27 (electric current ON).

On the other hand, if the IN signal is “0” (“L”), the output terminal of the inverter circuit Inv1 is “H,” and the p-channel transistor P27 is turned OFF. Thus, the electric current is not outputted from the OUT terminal.

As mentioned above, the unit electric current Iunit, outputted from the OUT terminal when the IN signal is set at “1,” is the same as the electric current Iref2 if the mutual conductance of the p-channel transistor P29 and the mutual conductance of the p-channel transistor P28 are the same.

In other words, in the electric current supplying circuit 303, the unit electric current Iunit is outputted from the OUT terminal if the IN signal is “1” (“H”). If the IN signal is “0” (“L”), the electric current is not outputted from the OUT terminal.

### (Light-Up Signal Speedup Portion)

When the light-up signal φI is supplied by the driving by the electric current, it takes time to turn off the electric current due to parasitic capacitance. In view of the above, the light-up signal speedup portion 204 forcibly switches the light-up control signal φJ from the ON state to the OFF state.

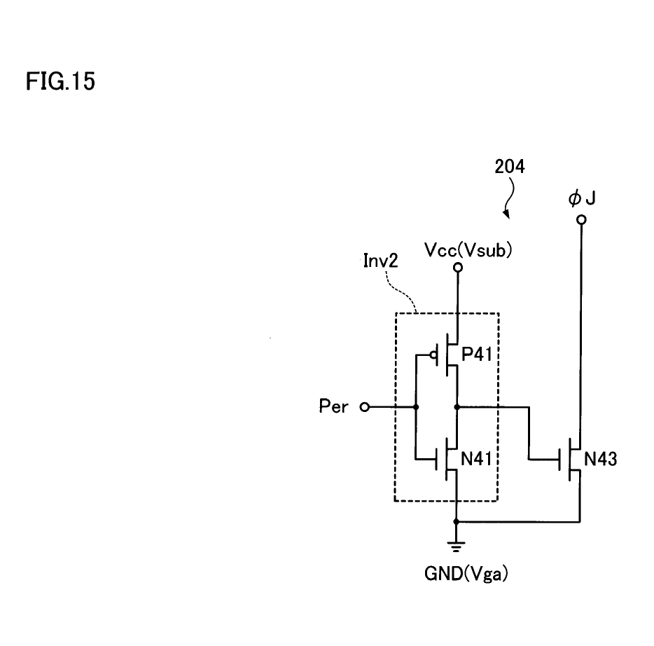

FIG. 15 is a circuit diagram for explaining the light-up signal speedup portion 204. In the present exemplary embodiment, the light-up signal speedup portion 204 is formed of CMOS circuits.

The light-up signal speedup portion 204 includes: an inverter circuit Inv2 whose input terminal is connected to the Per terminal; and an n-channel transistor N43.

The inverter circuit Inv2 includes a p-channel transistor P41 and an n-channel transistor N41.

The gate terminals of the p-channel transistor P41 and the n-channel transistor N41 are connected to each other, and thereby constituting the input terminal of the inverter circuit Inv2. The drain terminals of the p-channel transistor P41 and the n-channel transistor N41 are connected to each other, and thereby constituting the output terminal of the inverter circuit Inv2. The source terminal of the p-channel transistor P41 is connected to the Vcc terminal, and the source terminal of the n-channel transistor N41 is connected to the GND terminal.

The input terminal of the inverter circuit Inv2 is connected to the Per terminal, to which the light-up period signal Per is fed. The output terminal of the inverter circuit Inv2 is connected to the gate terminal of the n-channel transistor N43. The source terminal of the n-channel transistor N43 is connected to the GND terminal. In contrast, the drain terminal of the n-channel transistor N43 is connected to the φJ terminal.

When the light-up period signal Per is “H,” the output of the inverter circuit Inv2 is “L,” and the n-channel transistor N43 is OFF. In contrast, when the Per signal is “L,” the output of the inverter circuit Inv2 is “H,” and the n-channel transistor N43 is ON.

At timing when the light-up period Ton ends (the end of the light-up period), the light-up period signal Per changes from “H” to “L” (see FIG. 9). Then, the output of the inverter circuit Inv2 also changes from “L” to “H,” and the n-channel transistor N43 changes from OFF to ON. The electric potential of the light-up control signal φJ is drawn into the power supply electric potential Vga. As described above, the end of the light-up period is detected, and the electric potential of the light-up control signal φJ is forcibly set at the power supply electric potential Vga, whereby the change of the light-up control signal φJ from the ON state to the OFF state is accelerated.

It should be noted that the light-up signal speedup portion 204 does not require a new circuit because the light-up period signal Per is used for setting the light-up period Ton.

### (Light-Up Signal Feeding Circuit)

Next, a description will be given of the light-up signal feeding circuit 101.

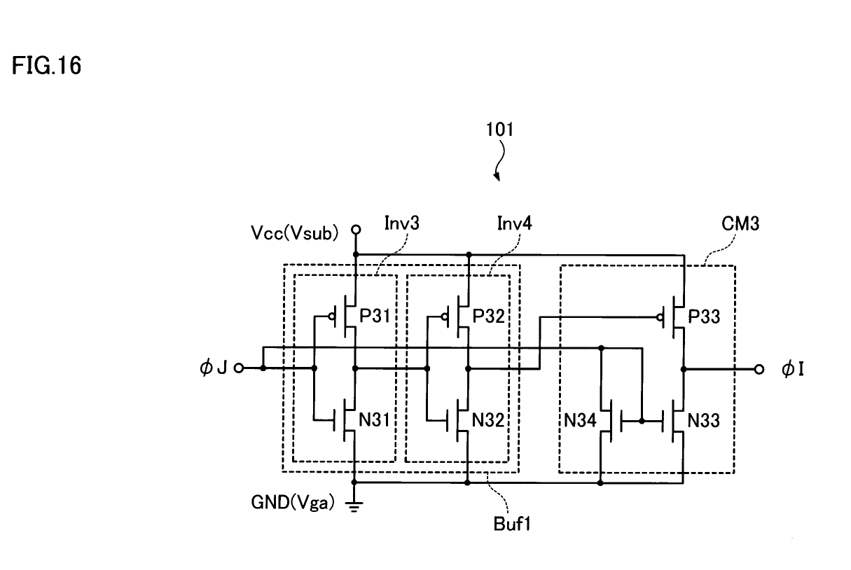

FIG. 16 is a circuit diagram for explaining the light-up signal feeding circuit 101. In the present exemplary embodiment, the light-up signal feeding circuit 101 is formed of CMOS circuits.

The light-up signal feeding circuit 101 includes a buffer circuit Buf1 whose input terminal is connected to the φJ terminal; and a current mirror circuit CM3.

The buffer circuit Buf1 includes an inverter circuit Inv3 that is formed of a p-channel transistor P31 and an n-channel transistor N31, and an inverter circuit Inv4 that is formed of a p-channel transistor P32 and an n-channel transistor N32.

The current mirror circuit CM3 includes a p-channel transistor P33 and an n-channel transistor N33 that are interposed between the GND terminal and Vcc terminal and serially connected to each other. Further, the current mirror circuit CM3 includes an n-channel transistor N34.

The gate terminals of the p-channel transistor P31 and the n-channel transistor N31 are connected to each other, and thereby constituting the input terminal of the inverter circuit Inv3. The drain terminals of the p-channel transistor P31 and the n-channel transistor N31 are connected to each other, and thereby constituting the output terminal of the inverter circuit Inv3. The gate terminals of the p-channel transistor P32 and the n-channel transistor N32 are connected to each other, and thereby constituting the input terminal of the inverter circuit Inv4. The input terminal of the inverter circuit Inv4 is connected to the output terminal of the inverter circuit Inv3. The drain terminals of the p-channel transistor P32 and the n-channel transistor N32 are connected to each other, and thereby constituting the output terminal of the inverter circuit Inv4. Each of the source terminals of the p-channel transistor P31 and the p-channel transistor P32 is connected to the Vcc terminal. Each of the source terminals of the n-channel transistor N31 and the n-channel transistor N32 is connected to the GND terminal.

The input terminal of the inverter circuit Inv3, which is also the input terminal of the buffer circuit Buf1, is connected to the φJ terminal, to which the light-up control signal φJ is fed. The output terminal of the inverter circuit Inv4, which is the output terminal of the buffer circuit Buf1, is connected to the gate terminal of the p-channel transistor P33. The drain terminal of the p-channel transistor P33 is connected to the drain terminal of the n-channel transistor N33. Further, each of the drain terminal of the p-channel transistor P33 and the drain terminal of the n-channel transistor N33 is connected to the 0 terminal, from which the light-up signal φI is outputted.

The gate terminal of the n-channel transistor N34 is connected to the gate terminal of the n-channel transistor N33 and the drain terminal of the n-channel transistor N34, and also connected to the φJ terminal.

Each of the source terminals of the p-channel transistors P31, P32, and P33 is connected to the Vcc terminal. In contrast, each of the source terminals of the n-channel transistors N31, N32, N33 and N34 is connected to the GND terminal.

Next, the operation of the light-up signal feeding circuit 101 will be described below. As mentioned above, the electric current units U to be used are selected depending on the number of the light emitting points (light emitting thyristors L) to light up simultaneously. Then, the unit electric currents Iunit flowing out of the OUT terminals of the selected electric current units U are superimposed with each other to form the light-up control signal φJ (see FIG. 13). The light-up control signal φJ is fed to the n-channel transistor N34. At this time, as shown in FIG. 9, the electric potential of the light-up control signal φJ is “H,” and the p-channel transistor P33 is turned OFF. Due to the current mirror realized by the n-channel transistor N34 and the n-channel transistor N33, the electric current, corresponding to the electric current flowing through the n-channel transistor N34, is drawn into the n-channel transistor N33 via the φI terminal. The electric current drawn via the φI terminal is changed into the light-up signal φI and causes the light emitting thyristors L to light up. Here, if the proportion of the mutual conductance of the n-channel transistor N34 to that of the n-channel transistor N33 is 1:10, ten times of the electric current flowing through the n-channel transistor N34 may be drawn via the φI terminal.

When the light-up signal φI is fed by the driving by the electric current, time is required for turning off the electric current due to parasitic capacitance. In view of the above, the light-up signal feeding circuit 101 includes the buffer circuit Buf1 and the p-channel transistor P33.

When the electric current of the light-up control signal φJ is lowered and further when the electric potential of the light-up control signal φJ changes from “H” to “L” and exceeds the threshold value of the inverter circuit Inv3 (i.e., more negative than the threshold value), the electric potential of the gate terminal of the p-channel transistor P33 is set at “L.” Then, the p-channel transistor P33 is turned ON. Thus, the electric potential of the φI terminal is forcibly set at “H” (reference electric potential Vsub), and the light-up signal φI is turned off.

When the electric potential of the light-up control signal φJ exceeds the threshold value of the inverter circuit Inv3, the buffer circuit Buf1 detects change in the electric potential of the light-up control signal φJ, turns on the p-channel transistor P33, and sets the light-up signal φI at “H” (reference electric potential Vsub). Accordingly, by withdrawing the electric charge stored on a base layer of the bipolar transistor of the light emitting thyristor L being lighting up, the switching of the light emitting thyristor L to the OFF state is accelerated.

On the other hand, at the end of the light-up period Ton, the light-up control signal φJ changes from “H” to “L” (see FIG. 9). In the light-up signal feeding circuit 101 shown in FIG. 16, while the electric potential of the light-up control signal φJ changes from “H” to “L,” the electric current stops flowing through the n-channel transistor N33, N34.

The light-up control signal φJ is connected to the gate terminal and drain terminal of the n-channel transistor N34 and also connected to the gate terminals of the p-channel transistor P31 and the n-channel transistor N31 of the inverter circuit Inv3. Accordingly, when the light-up control signal φJ holds an electric potential having a value intermediate between “H” and “L” in the change, the state of the inverter circuit Inv3 is reversed, and the output of the buffer circuit Buf1 also changes from “H” to “L.” Then, the p-channel transistor P33 is turned ON, and the light-up signal φI is no longer drawn. As a result, the light-up period Ton is shortened.

The electric potential for turning on the p-channel transistor P33 may be set near “L” by shifting the threshold voltage of the inverter circuit Inv3 to the “L” side. In this way, the shortening of the light-up period Ton may be suppressed. To achieve this, the mutual conductance of the n-channel transistor N31 constituting the inverter circuit Inv3 may be set at a higher value than the mutual conductance of the p-channel transistor P31. For example, the W/L proportion of the n-channel transistor N31 may be set higher than the W/L proportion of the p-channel transistor P31.

However, when W is set at a high value in order to set the W/L proportion of the n-channel transistor N31 at a high value, the speed of the light-up signal feeding circuit 101 may be lowered due to the increase in the electric capacity.

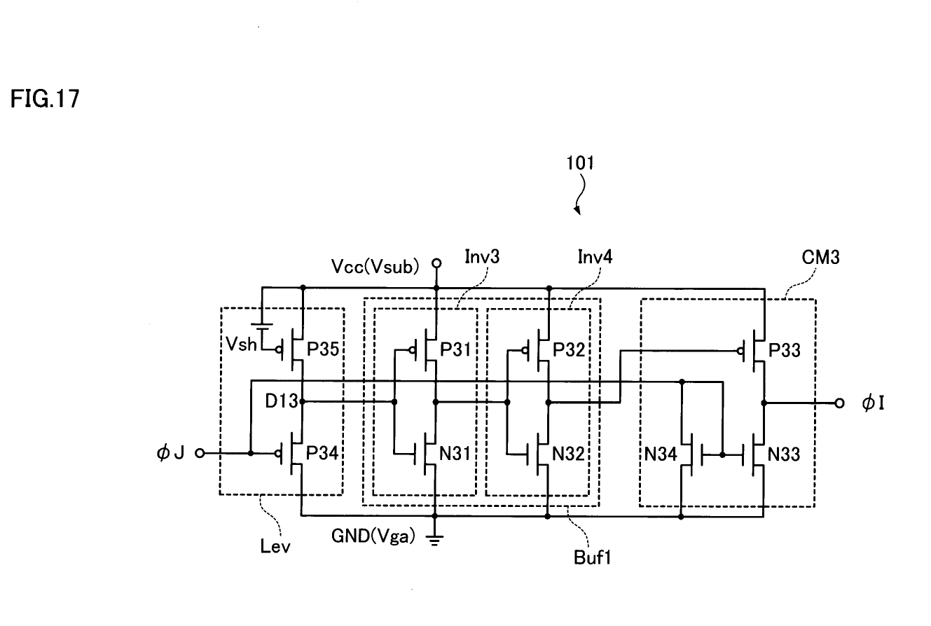

FIG. 17 is a circuit diagram for explaining another circuit configuration of the light-up signal feeding circuit 101.

The light-up signal feeding circuit 101 shown in FIG. 17 includes a level shift circuit Lev that is interposed between the φJ terminal and the buffer circuit Buf1 of the light-up signal feeding circuit 101 shown in FIG. 16. This configuration suppresses the reduction in the speed of the light-up signal feeding circuit 101.

The level shift circuit Lev includes p-channel transistors P34 and P35 that are serially connected at a connection point D13, and a power supply Vsh that generates a shift voltage.

The drain terminal of the p-channel transistor P34 is connected to the source terminal of the p-channel transistor P35 at the connection point D13. The source terminal of the p-channel transistor P34 is connected to the GND terminal, and the drain terminal of the p-channel transistor P35 is connected to the Vcc terminal.

The power supply Vsh supplies an electric potential that is lower than the reference electric potential Vsub of the Vcc terminal to the gate terminal of the p-channel transistor P35. The p-channel transistor P35 is set so as to be always turned ON.

When the light-up control signal φJ is “H,” the p-channel transistor P34 is OFF, and the electric potential of the source terminal (connection point D13) of the p-channel transistor P35 is set at the reference electric potential Vsub (“H”). Thus, the input terminal (connection point D13) of the buffer circuit Buf1 is set at “H,” the output terminal of the buffer circuit Buf1 is set at “H,” and the p-channel transistor P33 is turned off. In this way, the electric current (light-up signal φI), corresponding to the electric current flowing through the n-channel transistor N34 via the light-up control signal φJ, is drawn from the φI terminal into the n-channel transistor N33.

On the other hand, when the light-up control signal φJ changes from “H” to “L,” the p-channel transistor P34 is turned on at the electric potential between “H” and “L.” However, the electric potential of the connection point D13 is set according to the proportion of the mutual conductance of the p-channel transistor P34 to that of the p-channel transistor P35. Accordingly, while the light-up control signal φJ changes from “H” to “L,” timing when the p-channel transistor P33 is turned on is delayed by shifting the electric potential of the connection point D13 to the “H” side. In this way, the shortening of the light-up period Ton may be suppressed. Note that the shifting of the electric potential to the “H” side indicates that the electric potential of the connection point D13 is closer to “H” than to the middle value when the light-up control signal φJ is set at the middle value between “H” and “L.”

If the electric potential is shifted too much due to the back-gate effect of the MOS transistor, it may be an effective way to separate the source terminal of the p-channel transistor P34 from the board.

Although, in the present exemplary embodiment, the electric current supply unit U is formed by using the current mirror, the electric current supply unit U may be formed by using an amplifier with negative feedback. However, the current mirror may be often used in order to achieve a response speed more than several tens MHz.

The wire resistance of the light-up signal wire 75 of the light emitting chip C is estimated as 10Ω at most. The light-up electric current, supplied to one light emitting thyristor L being lighting up, is 10 mA. In this case, the driving by the electric current may be carried out with output impedance that is at least fifty times higher, and then the influence caused by the wire resistance is suppressed. In other words, the output impedance of the light-up signal feeding circuit 101 shown in FIG. 16 may be 500Ω or higher.

It should be noted that, if power supply voltage is to be increased, the output impedance of the light-up signal feeding circuit 101 may be set by inserting a resistance on the source side of the p-channel transistor or the n-channel transistor, or by connecting the p-channel transistor or the n-channel transistor serially to the p-channel transistor P33 or n-channel transistor N33.

Herein, a description of the light-up period setting portion 202 will be described later. As shown in FIG. 9, the light-up period signal Per generated by the light-up period setting portion 202 changes from “L” to “H” at the timing of the start of the light-up period Ton (the time point m). The light-up period signal Per changes from “H” to “L” at the timing of the end (the time point p). Thus, the light-up period signal Per may be generated easily.

Herein, the detailed description of the generating circuit of the memory signal φm is also omitted. When the memory signal φm is set at “H,” the reference electric potential Vsub is supplied. In contrast, when the memory signal φm is set at “L,” the power supply electric potential Vga is supplied. Instead, when the memory signal φm is set at “S,” an electric potential, between the reference electric potential Vsub and the power supply electric potential Vga, which is necessary for maintaining the ON state of the memory thyristor M, is generated to be supplied. The circuit for supplying these electric potentials (“H,” “L” and “S”) on the basis of the memory signal φm may be easily formed of CMOS circuits and the like.

Note that in the present exemplary embodiment, the number of the light emitting points in the light emitting chip C is described as 128. However, the number of the light emitting points may be set arbitrarily. Further, although the light emitting chip C includes one SLED in the above description, multiple SLEDs may be mounted on the light emitting chip C.

Additionally, in the present exemplary embodiment, one light-up signal φI and one memory signal φm are provided for each four of the light emitting chips C that are serially connected to each other. However, more than four light emitting chips C may be serially connected to each other. In addition, the light-up signal φI is not necessarily provided for each of the light emitting chip groups CG with serial connection. For example, only one light-up signal φI may be provided for the light emitting device 65 as long as the light-up signal φI is able to supply the light-up electric current in accordance with the number of the light emitting points (light emitting thyristors L) intended to light up simultaneously.

Note that the circuit configuration shown in the present exemplary embodiment is only an example, and another circuit configuration may be used instead. Further, although the CMOS circuits are used in the present exemplary embodiment, the circuit is not limited to be formed of the CMOS circuits. The circuit may be formed of a single channel transistor such as an n-channel transistor and a p-channel transistor or may be a bipolar transistor circuit.

In addition, in the present exemplary embodiment, the anode common thyristor (each of transfer thyristor T, memory thyristor M, and light emitting thyristor L) based on the anode terminal has been described. However, the cathode common thyristor (transfer thyristor T, memory thyristor M, and light emitting thyristor M) based on the cathode terminal may be used instead by changing the polarity of the circuit.

### <Reference Clock Generating Unit>

Next, a description will be given of the reference clock generating unit 116 of the signal generating circuit 100 shown in FIG. 10.

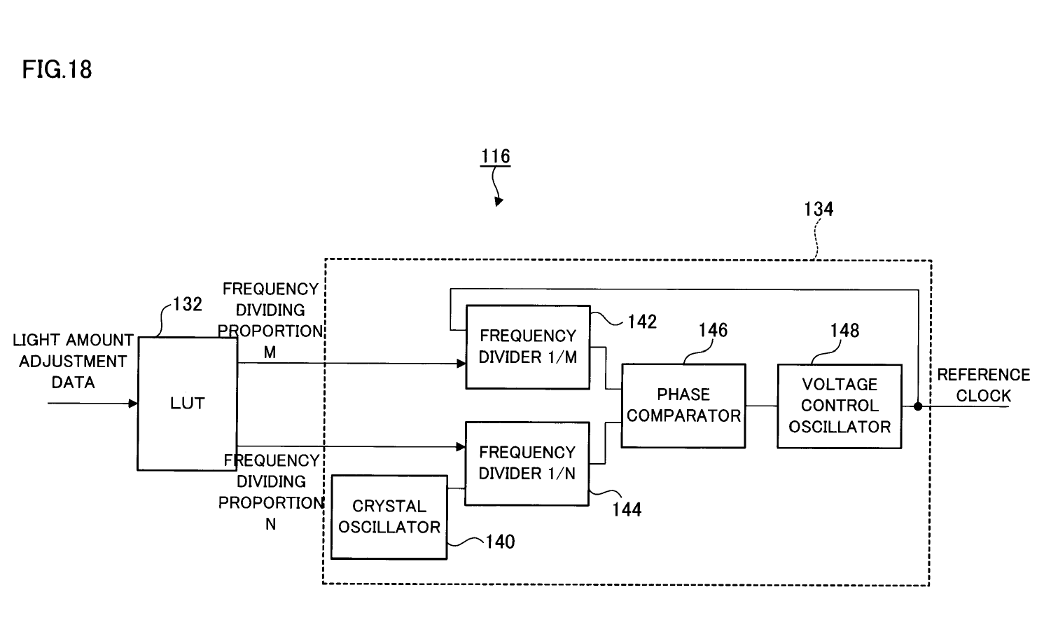

FIG. 18 is a block diagram for explaining a configuration of the reference clock generating unit 116 of the signal generating circuit 100 shown in FIG. 10.

The reference clock generating unit 116 includes a PLL circuit 134 that is formed of a crystal oscillator 140, a frequency divider 1/M 142, a frequency divider 1/N 144, a phase comparator 146, and a voltage control oscillator 148. The reference clock generating unit 116 also includes a look-up table (LUT) 132. The LUT 132 stores therein a table for determining the frequency dividing proportions M and N on the basis of the light amount adjustment data from the image output controlling unit 30. The crystal oscillator 140 is connected to the frequency divider 1/N 144. The crystal oscillator 140 is oscillated at a predetermined frequency, and then the signal obtained by the oscillation is outputted to the frequency divider 1/N 144. The frequency divider 1/N 144 is connected to the LUT 132 and the phase comparator 146. The frequency divider 1/N 144 divides the frequency of the signal obtained by the oscillation of the crystal oscillator 140 on the basis of the frequency dividing proportion N determined by the light amount adjustment data from the LUT 132. The phase comparator 146 is connected to the frequency divider 1/M 142, the frequency divider 1/N 144, and the voltage control oscillator 148. The phase comparator 146 compares the output signal from the frequency divider 1/M 142 with the output signal from the frequency divider 1/N 144. Depending on a comparison result (phase difference) obtained by the phase comparator 146, the control voltage supplied to the voltage control oscillator 148 is controlled. The voltage control oscillator 148 outputs clock signals at a frequency based on the control voltage. In the present exemplary embodiment, the control voltage corresponding to a frequency for dividing the potential light-up period into 256 pieces is supplied.

Then, the clock signals at the frequency are generated and outputted to all the light-up control signal generating units 110_1 to 110_10. Further, the voltage control oscillator 148 is also connected to the frequency divider 1/M 142. The clock signals outputted from the voltage control oscillator 148 are diverged and inputted to the frequency divider 1/M 142. The frequency divider 1/M 142 divides the frequency of the clock signals that are fed back from the voltage control oscillator 148 on the basis of the frequency dividing proportion M that is determined by the light amount adjustment data from the LUT 132.

### <Light-Up Period Setting Portion>

Next, a description will be given of the light-up period setting portion 202 shown in FIG. 11.

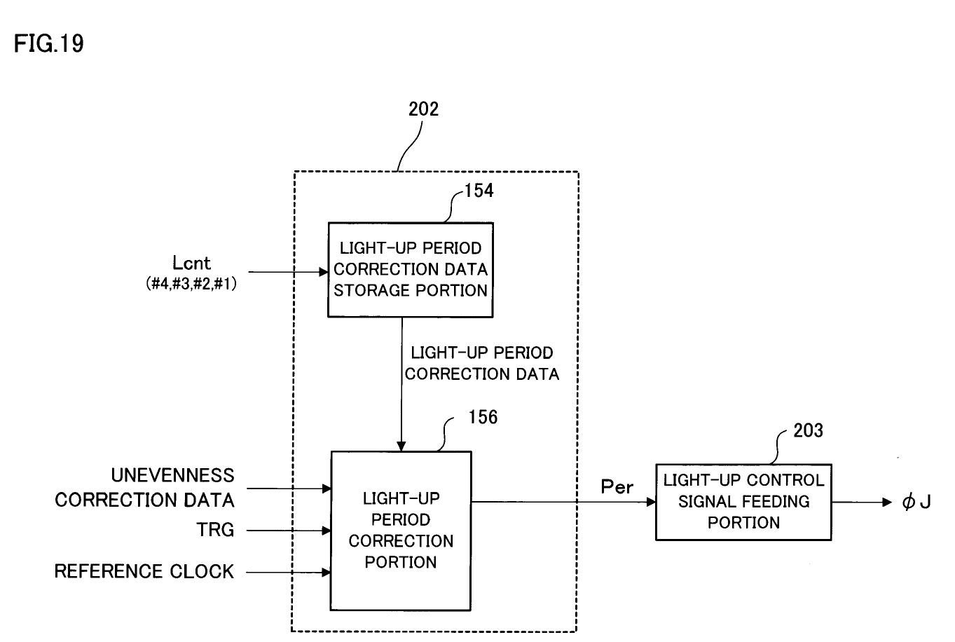

FIG. 19 is a block diagram for explaining the light-up period setting portion 202. Note that the light-up period setting portion 202 includes a light-up period correction data storage portion 154 that outputs the light-up period correction data on the basis of the light-emitting-point number setting signal Lcnt, and a light-up period correction portion 156. Here, the light-up period correction portion 156 obtains the unevenness correction data outputted from the density unevenness correction data unit 112 (see FIG. 10), and the light-up period correction data (light-up period correction information) outputted from the light-up period correction data storage portion 154. Then, on the basis of these signals, the light-up period correction portion 156 corrects the light-up period of each of the light emitting thyristors L to be caused to light up simultaneously and outputs the corrected light-up period as the light-up period signal Per.

Note that the light-up period correction portion 156 also obtains a trigger signal (TRG) outputted from the timing signal generating unit 114 (see FIG. 10), and a reference clock outputted from the reference clock generating unit 116 (see FIG. 18), and then outputs the light-up period signal Per at a predetermined timing based on these. In addition, the light-up period correction data storage portion 154 is a memory that stores therein light-up period correction data for correcting variation of the electric current supplying circuit 303 (three-state buffer) in correspondence with a light-up pattern (light-up combination) of the light emitting thyristors L in format of the look-up table (LUT) or the like.

Here, when the IN terminal is “1” (“H”) in the electric current supplying circuit 303, the reference electric current Iref1 is drawn from the CURIN terminal, and the unit electric current Iunit flows out of the OUT terminal. However, the electric current amplification factor of the electric current supplying circuit 303 varies in terms of characteristics in actual cases. Due to this variation, the electric current values of the outputted light-up control signals φJ (φJ1 to φJ10) vary. As a result, there is variation in the light amounts of the light emission of the light emitting thyristors L that are driven by the electric current.

In the present exemplary embodiment, this variation is corrected by the light-up period correction portion 156 in FIG. 19, whereby the variation in the light amounts of the light emission of the light emitting thyristors L is suppressed.

Specifically, the light-up period correction portion 156 obtains the light-up period correction data, which is determined on the basis of the light-up pattern of the light emitting thyristor L and the variation in the electric current amplification factor of the electric current supplying circuit 303 (three-state buffer). Then, the light-up period correction portion 156 corrects the light-up period of the light emitting thyristor L on the basis of the light-up period correction data, and outputs the light-up period signal Per to the light-up control signal feeding portion 203.

In this way, the variation in the electric current amplification factor of the electric current supplying circuit 303 (three-state buffer) of the light-up control signal feeding portion 203 may be correctable so as to correspond to the light-up pattern. Thus, the variation in the light amounts of light emission of the light emitting thyristors L may be suppressed. Further, because the variation in the light amounts of light emission of the light emitting thyristors L is suppressed, the number of the light emitting thyristors L to be caused to light up simultaneously may be increased more easily.

### <Description of Light Amount Correction Method of Light Emitting Element Head>

Subsequently, a light amount correction method of the light emitting element head in the present exemplary embodiment will be described by explaining the operation of correcting the light-up period of the light emitting thyristor L of the light-up control signal generating unit 110.

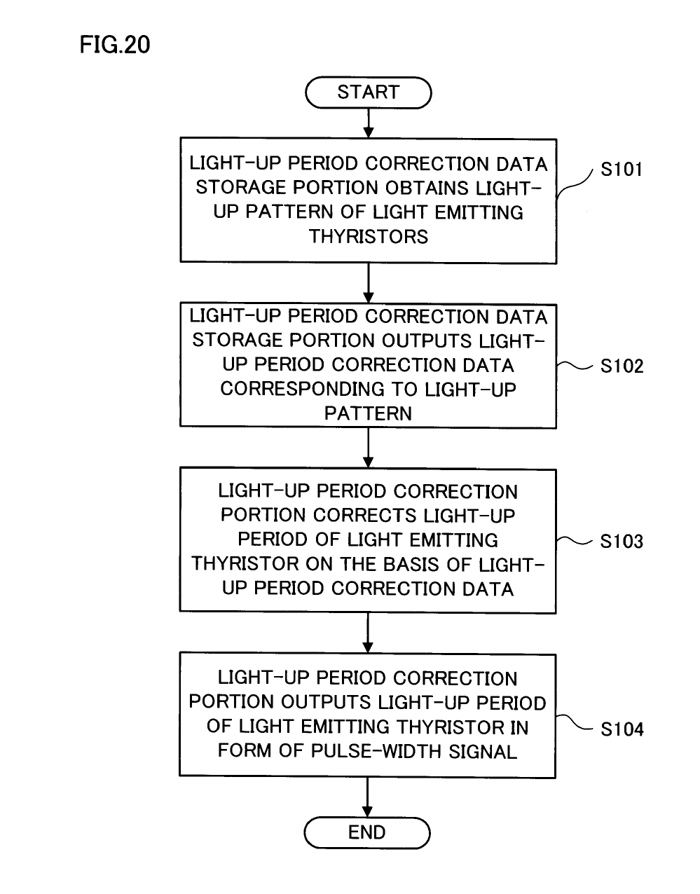

FIG. 20 is a flowchart for explaining the operation of correcting the light-up period of the light emitting thyristor L, performed in the light-up control signal generating unit 110.

Firstly, the light-up period correction data storage portion 154 obtains the light-up pattern (light-up combination) of light emitting thyristors L for each group by receiving the light-emitting-point number setting signal Lcnt outputted from the serial to parallel converting portion 152 (Step 101). This light-up pattern is outputted for each group performing the simultaneous light-up. The light-up period correction data storage portion 154 outputs the light-up period correction data corresponding to the light-up pattern to the light-up period correction portion 156 (Step 102). The light-up period correction portion 156 that has obtained the light-up period correction data calculates and corrects the light-up period of the light emitting thyristor L on the basis of the light-up period correction data (light-up period correction information) (Step 103). The light-up period correction portion 156 outputs the light-up period of the light emitting thyristor L to corresponding one of the light-up signal feeding circuits 101 (101_1 to 101_10) in form of a pulse-width signal which is adjusted by modulating the pulse width of a pulse signal (Step 104).

On the basis of the light-up period signal Per, each of the light-up signal feeding circuits 101 (101_1 to 101_10) generates the light-up signal φI and outputs the same as described above.

Note that when the light amount correction method of the light emitting element head described above is executed by a computer, the present exemplary embodiment may be a computer readable medium storing a program causing the computer to execute the following functions: a function for obtaining the light-up pattern (light-up combination) of the light emitting thyristors L divided into multiple groups to be caused to light up for each of the multiple divided groups, for each group, a function for obtaining the light-up period correction data (light-up period correction information) corresponding to the light-up pattern, and a function for performing correction of the light amount of the light emitting thyristors L on the basis of the light-up period correction data to correct and output the corrected light amount.

Note that when the four light emitting thyristors L are caused to light up simultaneously, there are 2⁴=16 light-up patterns. Accordingly, the 16 patterns of the light-up period correction data may be stored in the above-mentioned look-up table (LUT). In addition, when the 16 patterns of data are prepared for each of the light-up control signal generating units 110 (110_1 to 110_10), the number of light-up period correction data is 2⁴×10=160 in total.

Additionally, the above-mentioned example describes a case where the four light emitting thyristors L are caused to light up simultaneously. However, the number of the light emitting thyristors L to be caused to light up simultaneously is not limited. The light amount correction method in the present exemplary embodiment may be applied to, for example, the case where the eight light emitting thyristors L are caused to light up simultaneously. In this case, each eight of the light emitting thyristors L is regarded as a group, e.g., the light emitting thyristors L1 to L8, the light emitting thyristors L9 to L16, . . . , and so on, and each group is caused to light up in turn.

### EXAMPLES

### Example 1

The light emitting chip C, which is a self-scanning light emitting element array chip and illustrated in FIG. 5, is operated using the signal generating circuit 100 illustrated in FIG. 10. Here, eight light emitting thyristors L are caused to light up simultaneously. Then, an image is formed using the image forming apparatus 1 illustrated in FIG. 1.

The number of the electric current supplying circuits 303 (three-state buffers) included inside the light-up signal feeding circuit 101_1 (see FIG. 10) is eight as mentioned above. Respective values of the electric current amplification factors of the eight electric current supplying circuits 303 (three state buffers) are shown in Table 2.

TABLE 2

| | ELECTRIC CURRENT |
|---|---|
| BUFFER NO. | AMPLIFICATION FACTOR |
| 1 | 1.00 |
| 2 | 1.11 |
| 3 | 0.95 |
| 4 | 1.14 |
| 5 | 1.05 |
| 6 | 1.03 |
| 7 | 0.98 |
| 8 | 0.89 |

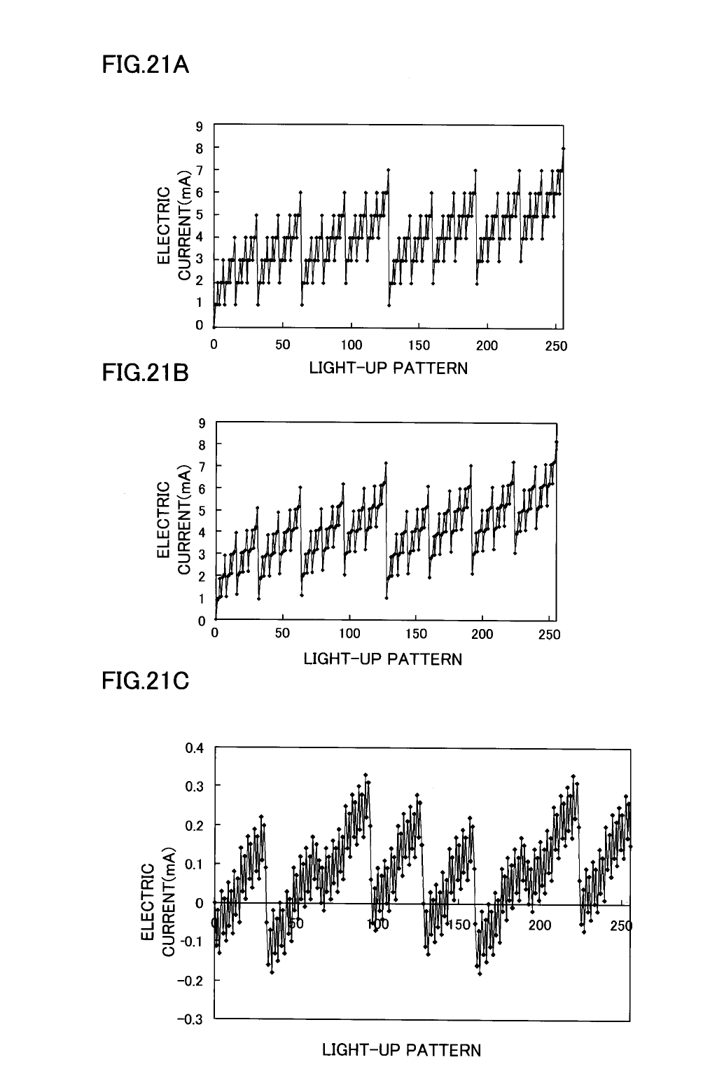

In addition, FIGS. 21A, 21B, and 21C are graphs for explaining the electric current value of the light-up control signal φJ1 outputted from the light-up signal feeding circuit 101_1 in the case of using the electric current supplying circuits 303 (three-state buffers) in Table 2.

Here, FIG. 21A is a graph illustrating the electric current value of the light-up control signal φJ1 for each light-up pattern on the ideal condition that the electric current supplying circuits 303 (three-state buffers) do not have variation, i.e., all the electric current amplification factors are the same. Further, FIG. 21B is a graph illustrating the electric current value of the light-up control signal φJ for each light-up pattern on condition that the electric current supplying circuits 303 (three-state buffers) have variation as shown in Table 2. Furthermore, FIG. 21C is a graph illustrating the difference between these electric current values for each light-up pattern. In other words, FIG. 21C illustrates an error from the ideal value of the output electric current for each light-up pattern of the light emitting thyristors L.

Note that in FIGS. 21A to 21C, the horizontal axis indicates 2⁸=256 patterns of the light-up patterns of the light emitting thyristors L with numbers 0 to 255, while the vertical axis indicates the electric current value with unit “mA.” Numbers of the light-up patterns are determined as follows. Firstly, the electric current supplying circuits 303 (three-state buffers) with buffers No. 1 to No. 8 are arranged in numerical order. Then, the binary is formed by setting “1” as a case when the input signal of the IN terminal of each electric current supplying circuit 303 (three-state buffer) is outputted as the output signal, and setting “0” as a high-impedance state. Then, 8-bit number formed of the binary is considered. The number is used as the number for the light-up patterns. For example, when the electric current supplying circuit 303 (three-state buffer) with the buffer No. 1 is at “1” and the others are at “0,” the binary number formed of these numbers is “10000000.” Accordingly, as a decimal number, the number of this light-up pattern is 2⁷=128, hence, “128.”

Light-up period correction data is made on the basis of the data illustrated in FIG. 21C and then stored in the light-up period correction data storage portion 154 (see FIG. 19) as the look-up table (LUT). With this light-up period correction data, the light-up period correction portion 156 may correct the variation in the output electric currents of the electric current supplying circuits 303 (three-state buffers). As a result, there is no noise in the image formed by the image forming apparatus 1.

### Comparable Example 1

The light-up period signal Per is outputted without considering the light-up period correction data in the light-up period correction portion 156 (see FIG. 19) of the signal generating circuit 100 illustrated in FIG. 10. Other than the configuration above, the image is formed on the same condition as the example 1. As a result, due to the variation in the output electric currents of the electric current supplying circuits 303 (three-state buffers), the light amounts of light emission of the light emitting chips C vary. Thus, a noise such as unevenness is found in the image formed by the image forming apparatus 1.

Note that, the usage of the light emitting device in the present invention is not limited to an exposure device used in an electrophotographic image forming unit. The light emitting device in the present invention may be also used in optical writing other than the electrophotographic recording, displaying, illumination, optical communication and the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting device comprising:
a self-scanning light emitting element array that includes light emitting elements divided into a plurality of groups, light-controlled for each of the groups, and arrayed in line; and
a light-up controller that sets any one of a voltage and a current for light-up, in accordance with the number of light emitting elements intended to light up in each of the groups.

2. The light emitting device according to claim 1, wherein the light-up controller obtains a light exposure amount correction value based on an average light exposure amount of the light emitting elements belonging to each of the groups, and sets a light-up period of the light emitting elements belonging to each of the groups on the basis of the light exposure amount correction value.

3. The light emitting device according to claim 1, wherein the light-up controller detects end of a light-up period of the light emitting elements belonging to each of the groups, and sets any one of the voltage and the current for the light-up at OFF.

4. The light emitting device according to claim 1, wherein the light-up controller changes light exposure amounts of the light emitting elements of the self-scanning light emitting element array by changing reference electric potential setting any one of the voltage and the current for the light-up.

5. The light emitting device according to claim 1, wherein the self-scanning light emitting element array further comprises a light-up signal supply portion that supplies any one of the voltage and the electric current for the light-up by driving by an electric current.

6. The light emitting device according to claim 5, wherein the light-up signal supply portion is formed of a current mirror circuit.

7. The light emitting device according to claim 6, wherein the light-up signal supply portion has an output impedance not less than 500Ω.

8. The light emitting device according to claim 5, wherein the light-up signal supply portion detects change in electric potential of a light-up control signal to be supplied to the light-up signal supply portion from the light-up controller, and sets a light-up signal to be supplied to the self-scanning light emitting element array at OFF.

9. The light emitting device according to claim 1, wherein the light-up controller further comprises:
an electric current supply portion that generates, via a buffer, an electric current supplied for each of the groups, and corresponding to a light-up combination of the light emitting elements forming each of the groups; and
a light-up period correction portion that obtains light-up period correction information determined on the basis of the light-up combination and an electric current amplification factor of the buffer, and that corrects a light-up period of the light emitting elements by using the light-up period correction information to output the light-up period which has been corrected to the electric current supply portion.

10. The light emitting device according to claim 9, wherein the buffer is a three-state buffer.

11. A print head comprising:
an exposure unit including:
a self-scanning light emitting element array that includes light emitting elements divided into a plurality of groups, light-controlled for each of the groups, and arrayed in line; and
a light-up controller that sets any one of a voltage and a current for light-up, in accordance with the number of light emitting elements intended to light up in each of the groups; and
an optical unit that focuses, on an image carrier, a light emitted from the exposure unit.

12. The print head according to claim 11, wherein the light-up controller further comprises:
an electric current supply portion that generates, via a buffer, an electric current supplied for each of the groups, and corresponding to a light-up combination of the light emitting elements forming each of the groups; and
a light-up period correction portion that obtains light-up period correction information determined on the basis of the light-up combination and an electric current amplification factor of the buffer, and that corrects a light-up period of the light emitting elements by using the light-up period correction information to output the light-up period which has been corrected to the electric current supply portion.

13. An image forming apparatus comprising:
a charging unit that charges an image carrier;
an exposure unit including:
a self-scanning light emitting element array that includes light emitting elements divided into a plurality of groups, light-controlled for each of the groups, and arrayed in line; and
a light-up controller that sets any one of a voltage and a current for light-up, in accordance with the number of light emitting elements intended to light up in each of the groups;
an optical unit that focuses, on the image carrier, a light emitted from the exposure unit;
a developing unit that develops an electrostatic latent image formed on the image carrier; and
a transfer unit that transfers an image developed on the image carrier to a transferred body.

14. The image forming apparatus according to claim 13, wherein the light-up controller further comprises:
an electric current supply portion that generates, via a buffer, an electric current supplied for each of the groups, and corresponding to a light-up combination of the light emitting elements forming each of the groups; and
a light-up period correction portion that obtains light-up period correction information determined on the basis of the light-up combination and an electric current amplification factor of the buffer, and that corrects a light-up period of the light emitting elements by using the light-up period correction information to output the light-up period which has been corrected to the electric current supply portion.

15. A light amount correction method of a print head, comprising
obtaining a light-up combination of a plurality of light emitting elements divided into a plurality of groups and lighting up for each of the groups, the light-up combination being set for each of the groups;
obtaining light-up period correction information corresponding to the light-up combination; and
performing a light amount correction of the light emitting elements by correcting a light-up period of the light-up elements on the basis of the light-up period correction information.

16. A computer readable medium storing a program causing a computer to execute a process for correcting a light amount, the process comprising:
obtaining a light-up combination of a plurality of light emitting elements divided into a plurality of groups and lighting up for each of the groups, the light-up combination being set for each of the groups;
obtaining light-up period correction information corresponding to the light-up combination; and
performing a light amount correction of the light emitting elements by correcting a light-up period of the light-up elements on the basis of the light-up period correction information.
